(19) United States
(12) Patent Application Publication
(10) Pub. No.: US 2018/0218449 A1
(43) Pub. Date: Aug. 2, 2018

(54) BUNDLES FOR AN EFFICIENT AUCTION DESIGN

(71) Applicants: Par Holmberg, Uppsala (SE); Keith Ruddell, Arsta (SE); Bert Willems, Ham (BE)

(72) Inventors: Par Holmberg, Uppsala (SE); Keith Ruddell, Arsta (SE); Bert Willems, Ham (BE)

(21) Appl. No.: 15/884,459

(22) Filed: Jan. 31, 2018

Related U.S. Application Data
(60) Provisional application No. 62/452,982, filed on Jan. 31, 2017.

(51) Int. Cl. G06Q 40/04; G06Q 30/08

(52) U.S. Cl. CPC G06Q 40/04; G06Q 30/08

(57) ABSTRACT

One aspect of our invention is a bundle rule that could make demand and/or supply of different packages more independent, which would simplify the bidding process, the verification that bids comply with a bidding format, clearing of the auction and presentation of information to traders. A second aspect is that bundling can be automatically updated with regard to auction relevant information before the auction starts or during the auction process. Several aspects of our invention can be combined in an exemplary design. Aspects of our invention can be implemented in computer systems.

### CROSS-REFERENCE TO RELATED APPLICATIONS

This application claims the benefit of the following provisional patent applications: “Bundles for an efficient auction design” (Application No. 62/452,982; filed 31 Jan. 2017).

### BACKGROUND

In the background we give examples of various types of auctions and exchanges that aspects of our invention could be applied to. We also introduce terminology that is relevant when describing aspects of our invention.

An auction is the process of trading a good or goods in accordance with a set of trading rules. The auction is conducted by an auctioneer. A “bidder” is a buyer and/or seller, who is normally not the auctioneer, that is interested in buying and/or selling good(s) traded in the auction. A “bid” is an instruction submitted by a bidder of how much it wants to trade under different circumstances. The bid normally indicates transaction price(s) acceptable to the bidder and sometimes transaction quantity(s) acceptable to the bidder at specified transaction prices. More specifically, an auction is a process where one or more bidders inform the auctioneer of their willingness to buy or sell a good or goods by making bids, and where an auctioneer then allocates the traded good or goods according to some rule that takes the bids into account.

Normally an auction would have a bidding format (which regulates what type of bids can be submitted and when they can be submitted), an allocation rule (which determines which bids are accepted), and a pricing rule (which determines transaction prices for accepted bids). An order-driven market is an example of an exchange that normally has all of these three properties. In this specification and claims we use the term auction in a general sense; it applies to any trading mechanism where at least one bidder makes bids and where trading is regulated by at least one of the following rules: bidding format, allocation rule and pricing rule. In particular, unless otherwise stated, the term auction includes all trading mechanisms that we discuss in this specification and related auctions, exchanges and trading platforms. In our specification, the terms auction format, auction design and auction rules have essentially the same meaning.

As in economics, we use the term “good” in a general sense in this specification; it could be anything (including services, financial instruments etc.) that provides utility or value to some potential buyer. Goods can be tangible or intangible. Examples of tangible goods traded in auctions are art, property, houses, animals and land. Examples of intangible goods are instruments, such as securities, currencies, intellectual property, insurance contracts, hybrid instruments (e.g. warrants and convertible bonds), derivatives, gambling contracts and emission permits. Auctions are important in e-commerce and business to business markets. The public sector and industry often procure services, subcontracting, machinery, components, material and construction projects in auctions.

In sales auctions, the auctioneer sells one or more goods and bidders submit bids to buy. Sometimes sales auctions are called forward auctions or buyer bidding auction. In procurement auctions, the auctioneer buys one or more goods and bidders submit bids to sell. Sometimes procurement auctions are called reverse auctions or supplier bidding auctions. Procurement auctions and sales auctions are one-sided, i.e. bids are coming from either sellers or buyers, not both. In double auctions, such as stock exchanges, derivative exchanges and commodity exchanges, both buyers and sellers are bidders that submit bids to the auction. Further background on double auctions is for example provided by Nymyer in U.S. Pat. No. 3,581,072 and by Molloy in U.S. Pat. No. 7,792,723. The latter focuses on a synthetic double auction that connects sales and procurement auctions by the actions of bidders. “A survey of the world's top stock exchanges' trading mechanisms and suggestions to the Shanghai Stock Exchange” by Gu (2005) provides details of how double auctions can be arranged.

To keep the presentation general we often use the terms “trade” or “transact” instead of “sell” or “buy”. As in the auction literature, we use the term “single object” or “single item” to denote an indivisible good or indivisible item, which cannot be divided between several bidders. A single-object auction trades an indivisible item, such as a piece of art or a house. An item could be anything that can be traded and allocated. A divisible-good auction trades a divisible, homogenous (or fungible) good. Similarly, a multi-unit auction trades a number of units of a good, such as a commodity, financial contract or security (including treasury and corporate bond, bill, note and stock). In the specification and claims, we use a general definition of the multi-unit auction, which encompasses all auctions that trade a plurality of units of at least one item type or fractions of at least one item. Thus divisible-good auctions are normally included in our definition of a multi-unit auction.

Our invention is mainly of interest for auctions that trade a plurality of heterogeneous (differentiated) goods, and bidders bid to buy or sell combinations (packages/bundles) of such goods. Such auctions are often called combinatorial or package auctions. In this specification, we use the terms combinatorial auction and package auction in a general sense; often we use these terms irrespective of whether traded items (bundles and/or goods that are part of a bundle) are indivisible, partly divisible or perfectly divisible. Combinatorial auctions can for example be used to allocate rights for entry capacity, exit capacity and transmission capacity in gas pipeline systems or electric power networks. Other examples are communication licenses, telecommunications spectrum, financial instruments, transportation routes, network routes, communication routes, tickets for different seats or occasions, landing and takeoff slots at airports, commodities with different qualities, or sponsored search slots on the web. Combinatorial auctions of the latter type are sometimes called position auctions. Power exchanges often clear a large geographical area and several delivery periods at the same time. Thus power exchanges are combinatorial auctions in that electricity in one location at one point of time is a different good to electricity in another location and/or at another point of time. Capacity markets are used by many electricity markets to secure that there is sufficient available production capacity in the market. These markets are often organized as auctions and they often consider that production plants could have different properties, for example in terms of location, ramp-rate, reactive power, and whether the plant would automatically adjust its output in response to changes in the system frequency. Participants in electricity markets can use Financial Transmission Rights (FTR:s) to hedge costs associated with transmission congestion. Auctions of such rights trade multiple units of related items and are used by many electricity markets. FTR:s are sometimes also referred to as Fixed or Firm Transmission Rights. U.S. Pat. No. 7,343,360 by Ristanovic et al. present an automated, on-line forward market for the exchange and scheduling of electrical power and for the auctioning of FTR:s. Auctions that allow participants to adjust their allocation of capacity obligations or FTR:s are sometimes referred to as Reconfiguration auctions.

Goods could be regarded as being heterogeneous even if they only have minor differences, such as terms of payment, quality of the good, currency of payment, delivery times, location of the good, transport cost etc. But sometimes an auction could also treat goods with minor differences as being homogenous. This is for example the case in zonal electricity markets, where electricity production inside a large region is treated as being homogenous. A detailed background of combinatorial auctions and more detailed examples of such auctions are provided in the following patents: U.S. Pat. No. 7,870,060 by Barker, Co and Grannan; U.S. Pat. No. 8,447,662 by Ausubel; U.S. Pat. No. 8,335,738 by Ausubel, Cramton and Milgrom; U.S. Pat. No. 6,026,383 by Ausubel; U.S. Pat. No. 7,792,723 by Molloy; U.S. Pat. No. 6,272,473 by Sandholm; U.S. Pat. No. 7,010,511 by Kinney et al.

In this specification, the terms package and bundle have essentially the same meaning. Packages or bundles are sometimes defined by an auctioneer that trades different goods. A package type could for example consist of two apples, three pears, one banana and half a coconut. A set of four apples, six pears, two bananas and one coconut would then correspond to two units of this particular package type. In general, we do not rule out the degenerate case where a package only contains one good or just one type of good. To keep our discussion as general as possible in the specification, we use the term “item” to denote a good or a package. Normally an item would be separable from other items, so that each item could be traded and allocated separately. If two items differ from each other, then we say that they are of different types.

We allow the number of units to be a non-integer number. This also includes fractions, which normally can be converted to a number. In our presentation, we also use the terms “quantity” and “volume”. Both of these terms have essentially the same meaning as “number of units” in our presentation.

In single object auctions, each bid normally consists of a single bid price. But in multi-unit auctions each bid often consists of a transaction schedule with price-quantity pairs, where the bid quantity of a price-quantity pair informs the auctioneer of how many units of an item the bidder is willing to trade at the bid price of the price-quantity pair. The price is normally a unit price (price per unit of an item). Normally the price would be expressed in some monetary unit (currency unit), such as dollar, euro, pound, peso, or rupee, or in terms of a currency index. The price could also be expressed in a digital currency, virtual currency, cryptocurrency, such as bitcoin, or an in-game currency. The price could also be expressed in other mediums of exchange, such as gold, other commodities or a financial instrument. The price could also be a price index, i.e. a weighted index of different currencies or mediums of exchange.

Sometimes we use the term “bid” to denote a subset of the price-quantity pairs in a transaction schedule. A bid could also be a buy or sell order in a financial exchange, or other information that expresses the preferences of the bidder for an item or items in terms of prices and/or quantities. We use the term “bid” both for sellers and buyers. Sometimes we also use “bid” as a verb instead of writing “make a bid” or “submit a bid”.

Some financial exchanges have liquidity providers, such as market makers, dealers or specialists, which often submit both buy and sell bids to an exchange or double auction. A liquidity provider could be considered to be one of the bidders. Sometimes there are liquidity providers that are approved by the exchange and that have special deals with the exchange. Such designated liquidity providers could for example be granted various informational and trade execution advantages, but also obligations. As an example, specialists are responsible for conducting the opening auctions in the New York stock exchange. Depending on the type of deal with the exchange, a liquidity provider could either be regarded as a bidder or being part of the auctioneer in our specification and claims. Thus an auctioneer could potentially consist of a plurality of agents that help with the operation of the auction. Some or all of the agents that help with the operation of the auction could be automatic processes. Similarly, a corporation (such as a business entity or company) may have several employees, automatic trading agents, or other representatives that are authorized to submit bids independently in the name of the same corporation. In such cases, a corporation could be considered to have a plurality of bidders, but normally bids submitted in the name of the same corporation are considered to be submitted by the same bidder in this specification. In case a broker submits a bid to an auction on behalf of a client, we would normally consider the broker to be the bidder in the auction, but depending on the rules of the auction it may sometimes be more appropriate to designate the client as the bidder. Also, we do not want to rule out that there could be special circumstances where at least one agent acts as both bidder and auctioneer in the same auction. In this specification and claims we use the term “trader” in a general sense. It would normally include any bidder. An auctioneer that is trying to sell a good (e.g. in a sales auction) or buy a good (e.g. in a procurement auction) is also considered to be a trader. We do not rule out that the term “bidders” (plural form) could represent a single bidder (singular). Similarly, the term “traders” could sometimes represent a single bidder and the term “traders” could sometimes represent a single auctioneer.

### Bidding Rounds

In standard sealed-bid auctions, also called static auctions, bidders—in one single bidding round—independently submit bids to the auctioneer, who then determines the auction outcome. Static auctions offer the advantage of speed in the operation of the auction. This is an advantage for financial markets and other markets that move fast and that should preferably be cleared in an instant. Moreover, static auctions are often used when the auction is repeated frequently or when one or more other but related items are traded frequently, so that bidders can fairly accurately predict the clearing price of the auction. For example electricity spot markets, treasury security auctions and frequent batch auctions are normally static auctions, but there are exceptions.

In ascending-bid auctions, bid prices start at or near a suggested opening bid, which is a favourable price for bidders. Thus an opening bid for sellers is normally high and an opening bid for buyers is normally low. In later bidding rounds, the bid price gets less attractive to bidders. i.e. further away from the opening bid. Thus, bidders tend to drop out of an ascending-bid auction or reduce their bid quantities in later bidding rounds. Bid prices are ascending in an ascending-bid sales auction, but bid prices would actually be descending in a corresponding procurement auction. We use the term “ascending-bid auction” in a general sense, so that the term also includes a procurement auction with descending bids. The popular English auction is an open outcry ascending bid auction, which is often used to trade single objects.

Ascending bid auctions and related auction designs with multiple bidding rounds offer the advantage that the auctioneer can choose to give some feedback to bidders about competitors' bids, for example regarding bids that have been received in previous bidding rounds. This facilitates the price discovery process of bidders. This is for example helpful in simultaneous ascending auctions where several related goods are traded in parallel with one ascending bid auction per good. Simultaneous ascending auctions are for example discussed by Cramton (2004) and in the background section of U.S. Pat. No. 7,133,841 by Wurman and Wellman.

An ascending-bid auction is one example of a dynamic auction. There are also other dynamic auctions, where bidders would normally iteratively submit bids until no more bids are forthcoming, until no more bids are accepted by the auctioneer, or until the auction has been cleared. Another example of a dynamic auction is an exchange with continuous bidding, where new bids are continuously received and cleared. A dynamic auction could take a break, for example during lunch, overnight, during the week-end, or during a holiday or holidays. A dynamic auction could end before the break, and bidders that want to keep uncleared bids active may have to resubmit them in a new auction after the break, or the auction could just take a pause and then continue with uncleared bids and new submitted bids after the break. Some exchanges with continuous bidding, opens and/or closes with an auction, where submitted bids clear at one point of time. In financial markets, such auctions are often referred to as call markets. U.S. Pat. No. 7,792,723 by Molloy discusses advantages and disadvantages with sealed bids and dynamic auctions in greater detail. Frequent batch auctions and continuous trading are compared and discussed further in “The High-Frequency Trading Arms Race: Frequent Batch Auctions as a Market Design Response” by Budish, Cramton and Shim (2013).

In a dynamic auction with a discrete bidding round structure, each bidder is often given the opportunity to submit a bid during a predetermined time interval for each round. But in a dynamic auction with continuous bidding, such as in an open outcry auction or a financial exchange, one could say that a bidding round ends as soon as the first bid has been submitted during the round (all bidders are normally welcome to make bids in the next round). The auction is normally cleared after the final bidding round. But in some cases, such as in some financial exchanges and other cases discussed in U.S. Pat. No. 6,026,383 by Ausubel, the auctioneer may also want to clear or partly clear an auction, even if the auction will continue with additional bidding rounds afterwards. Exchanges with continuous bidding normally try to clear every time a new bid is submitted. We do not rule out that a dynamic auction with continuous bidding can receive a plurality of (two or more) bids during the same bidding round. This could for example occur if a plurality of bids were submitted simultaneously (exactly or almost exactly at the same time) to the auction. Some auctions with continuous trading could be regarded as auctions with a discrete bidding round structure, for which the time interval per bidding period is very short, less than a couple of seconds. U.S. Pat. No. 8,335,738 by Ausubel, Cramton and Milgrom discusses advantages and disadvantages with using a discrete bidding round structure and continuous bidding in dynamic auctions.

An auctioneer may also run a sequence of auctions that are cleared at different points of time. When discussing up-dates of the auction design in this specification and claims, we sometimes consider such auctions to be part of the same auction process provided that they trade the same type of good(s), except that transaction, settlement and/or delivery could occur at different points of time.

Normally, bidders can choose bid prices themselves from a set of permissible prices. In this case we say that bidders explicitly choose bid prices. But in some dynamic auctions, such as clock auctions, the auctioneer (or an auction computer) presents a unit price for an item that it is ready to receive bids for. The presented unit price is sometimes referred to as the standing price or current price. In this case, it is sufficient for each bidder to communicate a bid quantity for the unit price presented by the auctioneer if the price applies to multiple units, or just indicate that it is willing or not willing to trade at that price if the price applies to a single object. Even if the bid price is actually presented by the auctioneer, each bid from a bidder is still valid for a specific bid price. Unless otherwise stated, this specification and our claims will mostly disregard whether a bid price is implicitly (as in clock auctions) or explicitly chosen by the bidder. A detailed background of clock auctions and examples of such auctions are provided in the following patents: U.S. Pat. No. 8,447,662 by Ausubel; U.S. Pat. No. 6,026,383 by Ausubel; U.S. Pat. No. 7,899,734 by Ausubel, Cramton and Jones; U.S. Pat. No. 8,335,738 by Ausubel, Cramton and Milgrom. FIG. 4 of U.S. Pat. No. 7,899,734 presents a detailed description of a clock auction trading multiple items, where a computer presents a list of prices for the items for each round, first in step 104 and then in step 114 for the following rounds. In each round, bidders submit bid quantities for the presented prices in step 108. Clock auctions are normally organized as ascending bid auctions.

To speed up the auction, clock auctions sometimes allow for “intra-round bids”, where, normally after getting feedback on the progress of the auction, bidders simultaneously and independently submit bids to the auctioneer often in a narrow price range decided by the auctioneer. All intra-round bids for that price range are normally submitted in the same round. Bid prices in clock auctions are normally implicit, but bid prices of intra-round bids are normally explicitly chosen by bidders. FIG. 8a of U.S. Pat. No. 7,899,734 illustrates in detail how a bidder could submit intra-round bids. The auction will then continue with a new round if the auctioneer was not able to, or did not want to, clear the market in that price range. The next round would normally be a round where bidders can submit bid quantities at a standing price presented by the auctioneer or a new round with intra-round bids.

Another way to speed up the process of a dynamic auction is to use an automatic bidding feature, proxy bidding. A client then submits sealed bids or other information on its preferences to a proxy agent. Similar to U.S. Pat. No. 8,335,738 by Ausubel, Cramton and Milgrom and U.S. Pat. No. 8,566,211 by Ausubel and Milgrom, we refer to such information as “flexible bid information”. Flexible bid information may include contingent bids that instructs the proxy agent on how to change a bid or bids when new information arrives, such as information on competitors' bids. Bids can also be contingent on the quality of a good, as discussed in U.S. Pat. No. 7,792,723 by Molloy, or contingent on something else. As for eBay, flexible bid information can include a limit price, such that the client is willing to trade at the specified limit price or at prices that are better from the client's perspective; a buyer normally prefers bid prices below the limit price and a seller normally prefers bid prices above the limit price. In case the proxy agent is bidding on behalf of a buyer, it will iteratively increase its bid price in small steps in an eBay sales auction until the limit price has been reached or until no competitor bids higher. As discussed in U.S. Pat. No. 8,335,738 by Ausubel, Cramton and Milgrom, clients are sometimes allowed to up-date flexible bid information after one or more bidding rounds in a dynamic auction. The proxy agent uses the flexible bid information and new information that arrives, such as information about competitors' bids, to automatically bid on behalf of the client in a dynamic auction. Auctions with proxy bidding are discussed in greater detail in U.S. Pat. No. 8,335,738 by Ausubel, Cramton and Milgrom. A proxy agent could be an automatic trading agent, such as the one discussed in U.S. Pat. No. 8,725,621 by Marynowski et al. The proxy agent is normally an automatic machine or process, but it can be human as in U.S. Pat. No. 6,449,601 by Friedland and Kruse. In financial markets, a (proxy) agent that submits bids on behalf of a client is often referred to as a broker or commission trader. Depending on the context, the term bidder in our specification and claims can represent a proxy agent or a client that submits flexible bid information to a proxy agent. In our specification, the term “bid” would normally include a bid submitted by a proxy agent, unless otherwise stated. There are also circumstances where flexible bid information, or parts of it—such as limit prices and contingent bids—can be regarded as bids.

U.S. Pat. No. 8,335,738 by Ausubel, Cramton and Milgrom uses the term “phase” to separate bidding rounds where bidding rules are significantly different. The U.S. Pat. No. 8,335,738, for example separates between a phase of non-proxy bidding and a phase with proxy bidding. This distinction is normally not necessary when discussing most aspects of our invention. Often aspects of our invention could be applied to a particular bidding round, a subset of bidding rounds, or all bidding rounds in an auction.

### The Bidding Format

The bidding format of the auction regulates the bidding process in detail. The following seven aspects are examples of details that are often regulated by the bidding format.

First, bidders are often restricted to (explicitly or implicitly) choosing unit prices from a list of permissible price levels. A price level could for example be an integer number (e.g. 7, 17 and 1100), a decimal number (e.g. 10.25, 7.0 and 120.237) or a fractional number (e.g. 2/7, 7/4 and 118/14). Note that a fractional number can be converted to a decimal number. Some fractional numbers, such as ⅓, cannot be exactly represented by a decimal number of finite length. However, in practice this would normally have a negligible influence on auction performance. In this specification and claims we will often treat fractional numbers as decimal numbers. When bidding on a house or flat, it could for example be required that bids must be in even thousands of dollars. The permissible bid price that is best from a bidder's perspective (and often worst from the auctioneer's perspective) is normally referred to as a reserve (or reservation) price. Hence, the highest permissible bid price for sellers is a reservation price for sellers and the lowest permissible bid price for buyers is a reserve price for buyers. If there are cases where the highest permissible unit price is not defined (including restrictions in the auction software), then we can define it to equal a very high number, such as 100 trillion dollars, or even positive infinity. If there are cases where the lowest unit price is not defined, then we can define it to equal zero, or if more appropriate, a very negative number such as negative 100 trillion dollars, or even negative infinity. In an ascending-bid auction, the reserve price is often referred to as a suggested opening bid. The opening price in an ascending-bid clock auction can also be regarded to be a reservation price. The absolute difference (the absolute value of the difference) between two adjacent permissible price levels for the same item is referred to as a tick-size (or minimum price increment) for that item. Thus the tick-size is normally the smallest amount by which the bid price can change.

As mentioned before, bidders do normally not explicitly choose bid prices (except for intra-round bids) in clock auctions and similar auctions. Still they make such choices implicitly, so our tick-size discussion often applies to such auctions as well; unit prices that are or can be presented by the auctioneer are normally regarded as permissible prices in our discussion.

U.S. Pat. No. 7,197,476 by Le, Morrison, Roberts, and Wiesehuegel discusses embodiments where bid increments that are smaller than the tick-size are allowed for some circumstances. They refer to this as off increment bids.

Second, in multi-unit and combinatorial auctions, bidders often choose bid quantities in their bids from a list of permissible quantity levels. A quantity level could for example be an integer number (e.g. 7, 17 and 1100) or a decimal number (e.g. 10.25, 7.0 and 120.237). A quantity level could also be a fraction, but normally they can be treated in a similar way as decimal numbers. The bidding format could for example require that quantities must be in even hundreds or thousands of units. In combinatorial auctions, the permissible quantity levels may be different for different items. The absolute difference between two adjacent permissible quantity levels for an item is referred to as a quantity multiple, lot size or minimum quantity increment. It depends on the clearing mechanism of the auction, but normally the lot-size is also the smallest amount by which the transacted quantity can change. Some auctions have upper bounds on the quantity that are intentionally restrictive. For example, US treasury security auctions have the 35% rule, which prevents anyone to buy more than 35% of the auctioneer's supply. One purpose with this purchase constraint is to prevent an auction participant from cornering the market of treasury securities. Spectrum auctions by the Federal Communications Commission (FCC) and California's auction of Greenhouse Gas emission allowances have had similar quantity restrictions. Upper bounds on the quantity are also used in some wholesale electricity markets where bids to sell can only be submitted for production capacity that has been registered at the auction in advance. If there are cases where the maximum quantity constraint is not defined by the bidding format (including restrictions in the auction software), then we can define it to equal a very large number, such as 100 trillion units, or even positive infinity. The patent application US 2016/0232603 by Holmberg et al. discuss tick-sizes and lot-sizes and how they can be used to improve auction performance in greater detail. In particular, they introduce automatic up-dating of tick-sizes and lot-sizes and bidding formats with non-constant tick-sizes and lot-sizes. U.S. Pat. No. 7,062,460 by Growney and Youssi for example discusses an auction where bidders are allowed to bid for sublots, i.e. volumes smaller than the lot-size, if they pay an extra price. In their case the additional cost reflected the higher transaction cost with trading sublots. US 2016/0232603 by Holmberg et al. also suggest that such a fine could be used to motivate bidders to submit bids that would enhance performance of the auction.

Third, bids in multi-unit auctions are often required to be monotonic. This means that a bidder is not allowed to submit bids that indicate that the bidder is willing to trade less at a unit price closer to the reservation price; bidders cannot offer to sell more as the price decreases or offer to buy more as the price increases. In clock auctions and multi-round auctions, such rules are often referred to as activity rules. In such auctions activity rules are particularly important, as they force bidders to be active early in the auction when the price is near the reservation price. Without activity rules bidders may refrain from submitting serious bids until near the very end of the auction. This would slow down and/or counteract the price discovery process, which often is the main purpose of having a dynamic auction. Activity rules can be quite complicated in combinatorial auctions when they trade multiple items of different types, and bidders may want to switch between items as the prices change. As an example, U.S. Pat. No. 7,899,734 by Ausubel, Cramton and Jones introduces an activity rule in step 110 of FIG. 4, which requires that a buyer must not increase its total bid quantity for related items when prices increases in the next round. FIG. 6a of U.S. Pat. No. 7,899,734 by Ausubel, Cramton and Jones verifies that bids comply with an activity rule and other bid constraints. As discussed by Ausubel and Cramton (2011), another way to deal with monotonicity for multiple items is to introduce a quantity index and then require that the quantity index is monotonic. In the literature on combinatorial auctions, the quantity index is sometimes referred to as (total) eligibility. Each item (which could be a package of goods) is then assigned a number of eligibility points, which corresponds to a weight in the quantity index. For each bidding round, a bidder's eligibility for an item is given by the bidder's bid quantity for that item multiplied by the assigned eligibility points of that item. A bidder's total eligibility is given by the bidder's summed eligibility for all items. Some activity rules of ascending-bid clock auctions then require that a bidder's total eligibility must not increase from one round to the next, when prices becomes less attractive for the bidder. The U.S. Pat. No. 8,447,662 by Ausubel discusses more complicated activity rules that take into account differences in the items and sometimes also bidders' preferences for the items that are revealed during the progress of a dynamic auction. Ausubel and Cramton (2011) discuss activity rules that take both revealed preference and eligibility into account. U.S. Pat. No. 6,718,312 by McAfee and Milgrom present more advanced activity rules for combinatorial auctions that include non-additive activity restrictions, subset restrictions and superset restrictions. Activity rules are also discussed in U.S. Pat. No. 8,566,211 by Ausubel and Milgrom.

U.S. Pat. No. 7,921,056 by Claus, Driscoll and Manning present a method to calculate a single composite value a weighted quantity of a plurality of trading products. Thus the single composite value is similar to an eligibility. However, in U.S. Pat. No. 7,921,056 the composite value is used to help traders that trade multiple items.

Fourth, each bidder can normally place several bids or price-quantity pairs in multi-unit auctions, but the maximum number of bids or price-quantity pairs per bidder and item is often restricted by the bidding format. Such a constraint is for example introduced for administrative purposes, in order to simplify the management of bids.

Fifth, in some auctions, bidders have financial constraints that have been registered at the auction beforehand that prevents them from making bids that, if accepted, would correspond to expenditures beyond their financial limit. This is to make sure that all bidders can make good on their promises. U.S. Pat. No. 8,447,662 by Ausubel discusses such constraints in the context of clock auctions.

Sixth, a sales auction would normally only accept bids from buyers and a procurement auction auction would normally only allow bids from sellers. In this case we say that the bidding format requires that bids are one-side.

Seventh, the bidding format also regulates when bids can be submitted. Normally, there is a time-period when bids can be submitted. Multi-round auctions would often have a different time-period for each bidding round.

Constraints in the bidding format and other details of the auction design are not necessarily announced. In case of computer implemented auction designs, some details could be “hidden” in the software. For example, the highest and lowest allowed prices, respectively, and other permissible prices are sometimes not explicitly announced by the auction, but in practice the auction software would normally anyway implicitly introduce bounds on those numbers, such as the maximum number of digits or the maximum number of decimal places that a bidder can use when choosing bid prices. Similarly, the set of permissible quantities may be due to restrictions in the number of digits and decimal places in the used software. The maximum number of price-quantity pairs per bidder could also be introduced due to a restriction in the used software.

Bids and their Properties

In auctions trading multiple units of a homogenous good, each seller would normally submit a supply schedule, a list of price-quantity pairs, which shows how many units the seller would be willing to supply at different prices. Even if bids are not submitted exactly in this way by bidders, they can anyway often be transformed into such an equivalent list of price-quantity pairs, and our discussion would apply to such cases as well. Similarly, a buyer would normally submit a demand schedule, which shows how many units a buyer is willing to purchase at different prices. A list of price-quantity pairs could be empty, e.g. in case a bidder is not interested in trading. We also allow a list of price-quantity pairs to consist of just one price-quantity pair. We use the more general term transaction schedule to represent either a supply schedule or a demand schedule.

As an example, assume that a bidder submits the following four price-quantity pairs as supply schedule and that bid quantities correspond to maximum quantities that the bidder wants to transact at the corresponding bid price:
10 units at $100 per unit
8 units at $80 per unit
6 units at $60 per unit
0 units at $0 per unit

Assuming that $0 is the lowest permissible price and that $200 is the reservation price, this would then imply that the bidder wants to sell 10 units at prices/unit of $100-$200, 8 units at prices/unit of $80-$100, 6 units at prices/unit of $60-$80 and 0 units at prices/unit of $0-$60. This relationship is illustrated graphically in FIG. 1. We refer to such relationships as a supply curve. We say that the supply curve is stepped, when it has a stepped shape as in FIG. 1. We say that this is a univariate supply curve, as the quantity of an item type that the bidder wants to sell only depends on the price of that item type. We use the term ‘univariate’ in a similar sense for transaction schedules/curves and demand curves.

Now, consider another example where we assume that a bidder instead submits the following four price-quantity pairs as bids to buy.
10 units at $0/unit
8 units at $80/unit
6 units at $100/unit
0 units at $200/unit

Also in this example, we assume that the bid quantity is the maximum quantity at the corresponding bid price. Assuming that $0 is the reservation price and that $200 is the highest permissible price, this would then imply that the bidder wants to buy 10 units at $0, 8 units at prices/unit of $0-$80, 6 units at prices/unit of $80-$100 and 0 units at prices/unit of $100-$200. This relationship is illustrated graphically in FIG. 2. We refer to such relationships as a demand curve.

The quantity of a price-quantity pair in a transaction schedule is referred to as a bid quantity. The price(s) of a price-quantity pair is referred to as the bid price(s). The bid quantity of a price-quantity pair would often represent the maximum (or minimum) quantity that a bidder wants to trade at the bid price(s) of the price-quantity pair.

The price-quantity pairs of a transaction schedule could be submitted in the same bidding round or in different bidding rounds. The former would be the case in a static multi-unit auction, which are often used in electricity markets and security auctions of the treasury. In clock-auctions, a bidder would often submit price-quantity pairs of its transaction schedule in multiple rounds. The latter case corresponds to a dynamic multi-unit auction.

A submitted bid is normally active until it has been cleared (executed), or until the auction has closed. It would normally no longer be active if it has been accepted in full. Normally a bid would also be inactivated when an auction closes. A bid might be partly accepted. In some dynamic auctions, such as in many financial exchanges, the unaccepted part of the bid could continue to be active. In some dynamic auctions, a bidder has the possibility to alter or cancel bids and/or to indicate a time period during which the bid is active. This is for example often the case in financial exchanges. Day orders in financial markets are valid for the trading day. Good-until orders are active (good) until a date specified by the bidder. Immediate-or-cancel orders (fill-or-kill orders) are active only when presented to the market. Good-after orders are active after some specified date. Some financial markets allow for various order types where bids are only activated (triggered) under special circumstances. Stop orders and market-if-touched orders are activated when the market price reaches a specified level. After these orders have been activated they are often treated as regular orders, until they expires. Tick-sensitive orders are contingent on the direction of the market price. One type of a tick-sensitive order would for example only be active when the market price is increasing. These and other order types are discussed in more detail by Gu (2005) and in the book “Trading and Exchanges” by Harris (2003).

A transaction schedule in our discussion would normally refer to an active transaction schedule, corresponding to active bid(s). In case a transaction schedule has partly expired or been partly cleared or withdrawn, or if the bidder has submitted or activated new bids, then bid quantities and bid prices of the revised active transaction schedule would be updated to reflect this.

Often the demand of the auctioneer in a multi-unit procurement auction would be constant up to the reservation price and zero above the reservation price. Similarly, the supply of the auctioneer in a multi-unit sales auction would be constant down to the reservation price and zero below the reservation price. But the auctioneer's demand/supply curve is more complicated in some auctions. Traders' demand and supply curves can be summed into aggregated demand and supply curves. If there is only one trader that is interested in buying (selling) units, then the aggregate demand (supply) curve would be equal to the demand (supply) curve of that trader, which could be the auctioneer. We let the more general terms ‘bid curve’ or ‘transaction curve’ denote either a ‘supply curve’ or ‘demand curve’.

In financial exchanges and related auctions, a bidder often submits a list of limit orders, which could be submitted independently at different points of time. In this specification and claims, a limit order (and similar order types) from a seller is included in the term ‘sell bid’ and a limit order from a buyer is included in the term ‘buy bid’. A sell bid is one type of bid and a buy bid is another type of bid. The specified price of a limit order is a bid price. Thus, the specified prices in a list of limit orders would correspond to the bid prices in the list of price-quantity pairs discussed above. The specified quantity of a limit order normally corresponds to a quantity increment, i.e. how much more the bidder wants to transact if the price moves towards the reservation price (upwards for a seller and downwards for a buyer) and reaches the specified price of the limit order. For a seller, the corresponding bid quantity of a price-quantity pair can normally be calculated by summing specified quantities (quantity increments) in limit orders of the seller, for which the specified price is equal to or less than the bid price of the considered price-quantity pair. For a buyer, the corresponding bid quantity of a price-quantity pair can be calculated by summing specified quantities (quantity increments) in limit orders of the buyer, for which the specified price is equal to or larger than the bid price of the considered price-quantity pair.

In this specification and in our claims, a bid price of a price-quantity pair in a transaction schedule is normally a price where the bidder wants to change the transacted quantity. A bid quantity of a price-quantity pair is normally a quantity, or one of the quantities (such as a maximum or minimum quantity), that the bidder wants to transact at the corresponding bid price. A bid curve is not necessarily stepped; a bid price could also indicate some other breakpoint in the bid curve of a bidder. In some auctions, such as the electricity spot market in the Nordic countries (Nord Pool Spot), he price-quantity pairs of a bidder are not connected by steps, as for stepped bid curves, but by linear lines forming a piece-wise linear bid curve.

DEFINITION: We say that a bidding round is a multi-bid round if a bidder is allowed to submit a plurality (two or more) of bids with different bid prices or a plurality of price-quantity pairs with different bid prices for units of an item in the same bidding round. We also say that auctions with continuous trading, such as most financial exchanges, have multi-bid rounds, as long as there is at least one bidder that can submit a plurality of bids with different bid prices for units of an item at essentially the same time, within minutes and sometimes without any bid of another bidder being submitted in the same time frame.

The multi-bid round criterion would normally be satisfied for multi-unit or combinatorial auctions that only have one bidding round. A bidding round with intra-round bidding in a dynamic auction would normally also satisfy the multi-bid round criterium. Call markets and frequent batch auctions would normally also satisfy the multi-bid round criterium.

The bids in the auctions and exchanges that we discuss normally have an explicit or implicit bid price, but there are exceptions. Financial exchanges often allow for market orders or unrestricted orders, which indicate that a bidder wants the order for an indicated quantity to be executed at the best available price without any price limit. ‘Non-competitive bids’ in security auctions by the US treasury are treated in a similar way. For a seller, the worst price would normally be the lowest permissible price. For a buyer, the worst price would normally be the highest permissible price. In many auction designs an unrestricted order and a non-competitive bid correspond to a limit order and a price-quantity pair, respectively, with a bid price at the worst permissible price (or some other very unattractive price) for the bidder. Thus our specification and claims is often applicable to such cases. Moreover, our specification and claims that concern bundles of an auction is also normally relevant for unrestricted orders, non-competitive bids and related bids, even if such bids or transaction schedules do not include explicit or implicit bid prices. In single object auctions, bidders would normally only submit bid prices (without any indication of quantity). Parts of our discussion and some aspects of our invention could apply also to such auctions, especially if traded items are bundles.

### Substitutes, Complements and Economics of Scope

Substitute goods or substitutes are products that a consumer perceives as similar or comparable, so that having more of one product makes them desire less of the other product. Assume that X and Y are different items. X and Y are then substitutes if, when the price of X rises, the demand for Y rises. Examples of substitute goods include margarine and butter, tea and coffee. In contrast, X and Y are substitutes if, when the price of X rises, the demand for Y decreases. Examples of complementary goods are hot dogs and hot dog buns. Independent goods are neither substitutes nor complements. Changes in the price of one good will have no effect on the demand for an independent good. For example, a consumer's demand for nails is usually independent of his or her demand for bread, since they are two unrelated types of goods. FIG. 5 presents a demand function for item 1 that only depends on the price of item 1 and is independent of the price of item 2.

Economics of scope means that it is cheaper to produce a range of products together than to produce each one of them independently on its own. Diseconomics of scope means that it is worse to produce products together than independently. Economics of scope and diseconomics of scope means that a producer should preferably not make production decisions independently for its products. For example, due to start-up costs in electricity markets, a producer's decision for one hour normally depends on its output in other hours.

We say that items are dependent if a bidder's willingness to transact one item depends on prices for other items that are traded in the same auction. All items are independent if there is no item type, such that a bidder's willingness to transact the item depends on prices for other items that are traded in the same auction. We use a similar terminology for packages and goods. Item dependence makes it time-consuming and therefore costly for a bidder to use bids to express its preferences for traded items. As an example, if there are two different and dependent items that are traded in the same auction, then the bidder would preferably like to condition the transacted volume of each item on both prices. Thus the term price-quantity pair should be interpreted generally, it could be a tuple. FIGS. 3 and 4 present supply functions and demand functions that are conditional on two prices. Standard textbooks in Microeconomics, such as Varian (1992) and Mas-Colell, Whinston and Green (1995), discuss such multivariate demand and supply functions and their properties for general markets and multiple (two or more) types of items. We let the term ‘multivariate bid curve’ or ‘multivariate transaction curve’ denote either a ‘multivariate supply curve’ or ‘multivariate demand curve’.

In some electricity markets, such as in Pennsylvania-New-Jersey-Maryland (PJM), producers are allowed to explicitly express their start-up costs as part of their bids. In the Spanish and Nordic market (Nord Pool), producers can, for similar reasons, condition sales in one delivery hour on prices in adjacent hours. This is sometimes referred to as complex bidding (Reguant, 2014).

The problem with a multivariate bid curve is that there could be many price combinations, for which a bidder should specify its willingness to transact each item. Assume that a bidder is interested in transacting two types of items in a region of prices with 100 permissible prices for each item, then it may have to specify its multivariate bid curve for 100×100=10,000 different price combinations. The problem would be even larger if there are more than two types of items. Below we illustrate this for the case where both price levels are of interest to a buyer who is interested in buying both types of items. The indicated volume could for example be a maximum (or minimum) quantity that the buyer is willing to buy for given prices.

| | Price item 1 | Price item 2 |
|---|---|---|
| Volume of item 1 | | |
| 10 units | $2/unit | $4/unit |
| 9 units | $2/unit | $5/unit |
| 6 units | $3/unit | $4/unit |
| 5 units | $3/unit | $5/unit |
| Volume of item 2 | | |
| 12 units | $2/unit | $4/unit |
| 8 units | $2/unit | $5/unit |
| 11 units | $3/unit | $4/unit |
| 7 units | $3/unit | $5/unit |

In this example, units were complements for the buyer in the considered price range as demand of an item goes down if the price of the other item increases. Note that it would also be possible to arrange auctions for multiple types of items where a buyer specifies inverse multivariate demand functions, i.e. where it for each item type specify prices that it is willing to pay as a function of volumes for multiple (two or more) types of items. Similarly a seller could specify an inverse multivariate supply function.

Klemperer (2008) suggests an alternative way of submitting bids when goods are substitutes. Each bid has a single bid quantity and for each type of item, the bidder specifies at what per-unit price it would be willing to transact that bid quantity for that item type. In case the bid is accepted, it will only apply to one of the item types. Milgrom (ARJ, 2007) analyses assignment messages, which is a general way for bidders to express their preferences for related items. U.S. Pat. No. 8,543,483 by Dietrich, Nisan (2000) and Peke and Rothkopf (2003) discuss alternative bidding languages for combinatorial auctions. U.S. Pat. No. 7,844,540 by Boutilier and U.S. Pat. No. 7,835,980 by Boutilier and Hoos allow for bids in a combinatorial auction that include logical operators.

From a bidder's point of view, it could be simpler to submit bids for multiple types of items in a clock auction, as it is sufficient to specify volumes for prices presented by the auctioneer. However, from the auctioneer's perspective it will become more difficult to run a clock auction with multiple items. For example, it would become more complicated to predict how bidders will respond to price changes, in case changing the price of one type of item would also change bidders willingness to trade other types of items. Also it takes more time to run a clock auction compared to a single round auction, and this increases the transaction cost.

Cross-price sensitivity can be used as a measure of economies of scope and/or the degree of substitutability/complementarity. Let P be a vector of possible unit prices for relevant packages. The vector includes P_{B}, a unit price of package B. Assume that a bidder is willing to transact Q_{A} units of package A at the vector of prices P. Next, we let ΔP_{B} be a small change in the price of package B; other prices in P are kept unchanged. In theory, the price change could be infinitesimally small, but in practice it might be useful to consider a larger change. For example, in some cases it might be relevant to consider a price change that is sufficiently large to change the reported number of units that a trader is willing to trade of some package according to its transaction schedule. Let ΔQ_{A} be the resulting change in the number of units that the trader is willing to trade of package A. We can use these terms to define the trader's cross-price sensitivity, E_{AB}, as follows:

E_{AB}=ΔQ_{A}/ΔP_{B}.

The considered price change could be smaller or larger, but roughly one can say that the cross-price sensitivity E_{AB} measures the change in the trader's willingness to transact package A if the price of package B changes by 1 price unit. Typically ΔQ_{A}/ΔP_{B}<0 for a buyer would indicate that packages A and B are complements and ΔQ_{A}/ΔP_{B}>0 for a buyer would indicate that packages A and B are substitutes at considered prices. However, the sign of the ratio ΔQ_{A}/ΔP_{B} can also depend on the magnitude of ΔP_{B} and on the income effect. For a seller, we normally have ΔQ_{A}/ΔP_{B}>0 when there is economics of scope and ΔQ_{A}/ΔP_{B}<0 when there is diseconomies of scope. For sufficiently small price changes, microeconomic theory predicts that cross-price sensitivities should be symmetric, so that E_{AB}=E_{B}, but this may not always hold in practice.

DEFINITION: We say that cross-price sensitivities are approximately symmetric if E_{AB} and E_{BA} differ by at most 1% of E_{AB} for all items in the auction.

Similarly, we can define an own-price sensitivity of the trader at the vector of prices P as follows:

E_{AA}=ΔQ_{A}/ΔP_{A},

where ΔP_{A} is a small change in the price of package A. Normally, we have E_{AA}<0 for a buyer. However, there are exceptions as for Giffen goods. Normally, we have E_{AA}>0 for a seller. For the trader, we can also define a relative cross sensitivity E_{AB}/E_{AA}, We say that packages A and B are approximately independent for the trader at prices P if it is estimated that E_{AB}*E_{BA}=0 or IE_{AB}*E_{BA}/(E_{AA}*E_{BB})|<0.02, where we use the absolute value (modulus) operator II to ensure that the ratio is non-negative. Note that it follows from this definition that the two packages are approximately independent if E_{AB}*E_{BA}=0, even if E_{AA}*E_{BB}=0.

DEFINITION: For a group of traders, we say that a set of package types are approximately independent at a vector of prices P, which includes prices for all package types in said set, if package types are approximately independent at P for all possible pairwise combinations of package types, and if this is true for all traders in the considered group.

We say that packages A and B are approximately perfect substitutes/complements for the trader at P if it is estimated that |E_{AB}*E_{BA}/(E_{AA}*E_{BB})|>0.8.

DEFINITION: For a group of traders, we say that a set of package types are approximately perfect substitutes/complements at a vector of prices P, which includes prices for all package types in said set, if package types are approximately perfect substitutes/complements for all possible pairwise combinations of package types, and if this is true for all traders in the considered group.

Price sensitivities could be straightforward to estimate in case a trader has submitted a multivariate transaction schedule. Otherwise, the price sensitivities of a trader may not be directly observable, but they can for example be estimated from data from related markets, previous related auctions or from previous bidding rounds in the same auction. In case there is little data or for other reasons, it might be useful to assume that a group of traders have identical price sensitivities, or that they are somehow related. Revealed preference is one technique that can be used to estimate price sensitivities (see for example Varian (2006)). But there are also other standard econometric methods that can be used to estimate price sensitivities.

As discussed in the next section, a trader will in some auction designs have incentives to choose a transaction schedule strategically, such that it does not exactly correspond to its true preferences or true costs. In such cases and if there is sufficient data, it would often be possible to back out price sensitivities of a trader's true preferences or costs. Such methods have been established in the academic literature.

Purchases of a consumer are often limited by a budget. As discussed in the section on the bidding format, firms sometimes have similar financial constraints when taking part in an auction. It is well-known from microeconomic theory, see for example Varian (1992), that a trader's price sensitivities can be influenced by an income effect under such circumstances.

Details regarding the influence from income effect and strategic effects and estimates of those effects can be relevant for auction performance. But we want to focus on other issues in this specification. Thus, our intention is that our definition of approximate independence above should be interpreted in a broad sense. It could be applied to estimated true costs and preferences, or be applied to estimates of price sensitivity that are partly driven by strategic effects. Moreover, the definition could be applied to cases that consider income effects or where income effects are irrelevant or have been neglected when estimating price sensitivities. For example, the definition could be applied to both Marshallian demand, where income of a consumer is normally kept fixed when analyzing effects of price changes, and Hicksian demand, where income of a consumer is normally adjusted to keep its utility constant when analyzing effects of price changes.

### Allocation and Pricing Rules

The auction format often includes rules that decide the transacted quantity (the allocation rule) and transaction price(s) of each bidder (the pricing rule). The allocation decision is often straightforward in single object auctions. After the auction has closed, the auctioneer would normally simply accept the bid with a bid price that is furthest from the reservation price, i.e. the lowest sell bid or highest buy bid.

In multi-unit auctions, the allocation is normally such that the total quantity bought by traders equals the total quantity sold by traders, where the auctioneer could be one of the traders. Thus the market for one type of item is often cleared at a point where the aggregate supply curve equals the aggregate demand curve, where either the aggregate supply curve or aggregate demand curve could represent the quantity that the auctioneer wants to transact. In our specification we refer to the clearing price as the marginal price. In an auction that trade multiple types of items, clearing prices are normally such that aggregate supply equals aggregate demand for each type of item. In such cases, marginal prices are typically different for different types of items. Note that a bidder's transaction price of an item may differ from its marginal price.

Deciding what bids to accept is sometimes less straightforward for a combinatorial auction that trades multiple types of items, especially if items are indivisible. In this case, the auctioneer's acceptance decision problem is sometimes referred to as the winner determination problem. U.S. Pat. No. 6,272,473 by Sandholm, U.S. Pat. No. 7,043,446 by Dietrich and Forrest, Sandholm (1999), Fujishima, Leyton-Brown and Shoham (1999) and Andersson, Tenhunen and Ygge (2000) all outline algorithms for solving this problem. Often the allocation is chosen such that stated welfare is maximized. This means that the auctioneer, when determining the allocation, assumes that all bids are truthful in the sense that they are true statements of sellers' costs and of buyer's valuations. Stated costs and stated valuations can be aggregated for the whole market, and the auctioneer can then try to choose the allocation such that the total stated value of buyers minus the total stated cost of sellers is maximized. In textbooks on electricity markets, this is sometimes referred to as an Economic dispatch problem. However, it is not certain that a welfare optimum exists, for example if items are very strong complementary goods.

As for example discussed in U.S. Pat. No. 8,335,738 by Ausubel, Cramton and Milgrom, sometimes auctioneers also take bid related information into account when accepting bids, such as terms of payment and delivery (settlement), and the use to which the auctioned one or more items will be put. Acceptance of a bid in Google's and Yahoo's keyword auctions takes into account a quality score of an ad that considers the click through rate, relevance of text and historical keyword performance. Bidder specific information that might be taken into account when accepting bids is location, credit-rating, minority status, foreign or domestic status of the bidder etc.

In principle, the clearing process is the same in clock auctions. In such auctions the clearing price is normally found in the following way. The opening price of a clock auction is normally very favourable to bidders. Thus they are normally willing to trade more units of an item at that price than the auctioneer is willing to transact. Bidders' interest to trade units is then reduced as the price gets less favourable in the next rounds. A basic clock auction ends when the aggregate minimum quantity that bidders want to transact of an item at the current price is equal to or lower than the quantity that the auctioneer wants to transact. In practice it is sometimes desirable to stop a clock auction earlier, when the aggregate minimum quantity that bidders want to transact of an item at the current price is sufficiently close to the quantity that the auctioneer wants to transact. An embodiment for cases when multiple related items are traded is illustrated in step 112a-2 of FIG. 7 in U.S. Pat. No. 7,899,734 by Ausubel, Cramton and Jones. The current price of the final round sets the marginal price of the item. In case an auctioneer wants to trade multiple items of different types, one possible implementation is to run several parallel clock auctions, one for each item.

U.S. Pat. No. 7,899,734 by Ausubel, Cramton and Jones also explains the operation of a sales clock-auction with intra-round bids in detail, for cases with multiple related items. As explained in detail in FIG. 8b and 8c of U.S. Pat. No. 7,899,734, such an auction is stopped after an intra-round if there is some bid price in the last round where the aggregate minimum quantity that bidders want to transact of an item at this bid price is less than or equal to the quantity that the auctioneer wants to transact. In this case, the auction clears at the lowest such bid price in a sales auction and at the highest such bid price in a procurement auction. This clearing price gives the marginal price in our specification and claims.

Allocation is not necessarily rule-based, an auctioneer may accept bids on its own judgement. In real-time electricity markets, a system operator sometimes accepts bids on its own judgement taking for example bid price, but also switching time (ramp rates) of generation, location of generation and various power system constraints, into account when making its decision. In exchanges that are quote driven dealer markets, dealers announce buy and sell prices that clients can choose to accept or reject. In this case, dealers sometimes only trade with clients that they believe are trustworthy and creditworthy. A dealer may also refuse to trade with someone outside its preferred clientele and they sometimes try to avoid trading with well-informed clients. Quote-driven exchanges are discussed in more detail by Harris (2003). U.S. Pat. No. 8,489,493 by Nager presents embodiments of quote-driven exchanges. Many exchanges are hybrid markets, which mix characteristics of order-driven and quote-driven markets. New York Stock Exchange is essentially an order-driven market, but it requires specialist dealers to offer liquidity (submit bids) if no one else will do so. The Nasdaq Stock Market is essentially a quote-driven market, but it also has characteristics of an order-driven market. The contribution in U.S. Pat. No. 8,489,493 by Nager is how to implement an exchange that can quickly, in real-time, change between an order-driven, quote-driven and hybrid market.

A pricing rule of the auction format regulates how much accepted bids should pay or be paid. In uniform-price (single price), multi-unit auctions, all accepted bids for a particular type of item are transacted at a uniform clearing price, which is set by its marginal price. The product-mix auction in Klemperer (2010) is an example of this. In first-price (single object) and pay-as-bid/discriminatory (multi-unit) auctions, each accepted bid is transacted at its own bid price. In second-price, generalized second-price, Vickrey and Vickrey-Clarke-Groves (VCG) auctions and in auctions with core pricing, the transaction price of accepted bids is normally different to the marginal price and partly or completely determined by the bid price of competitors' bids. There are also auctions where bids that are not accepted in the auction have to pay or get paid, such as “all pay auctions”. Standard auction formats are discussed by Klemperer (2004) in “Auctions: Theory and Practice”. U.S. Pat. No. 7,729,975 by Ausubel, Cramton and Milgrom; Day and Milgrom (2008); Day and Cramton (2012) discuss auctions with core outcomes. Normally, transaction prices in an auction occur at prices that are permissible for bidders, but this is not necessarily the case.

Many order-driven stock markets and many electronic futures markets open with a single price call market (auction) before continuous trading is started. In this case, orders submitted to the call market are normally cleared simultaneously at a uniform-price. A session with continuous trading may also close with a similar auction. Normally exchanges with frequent batch auctions would clear at a uniform-price at regular intervals, see for example Budish, Cramton and Shim (2013). Arizona Stock Exchange used to trade U.S. equities in a single-price auction.

Block orders are orders with unusually large bid quantities, such as more than 10,000 stocks, or that correspond to an unusually high market value. The liquidity in a public exchange is often not sufficient to trade a block order. Therefore a counterparty that is ready to trade a block order is often found by a broker outside a public exchange. Such a match is often referred to as crossing. A broker can also cross orders with smaller bid quantities from its clients. Crossing is often regulated, for example by Regulation NMS in U.S., it may for example be the case that such trades can only be executed at the market price and that such trades have to be registered at a public exchange. In addition, before registering a crossed trade at a public exchange, active orders at better prices in the exchange may fully or partly displace orders matched by crossing. This process is sometimes referred to as to print a trade. Crossing may involve multiple clients and it could be organized similar to an auction.

Crossing networks are normally order-driven exchanges where all accepted bids transact at the same price, but unlike a uniform-price auction the transaction price is set by another market; normally a public exchange. One can therefore say that crossing networks use a derivative pricing rule. Crossing networks often rank and match orders similar to an order-driven market, and the allocation is normally such that the total quantity bought by traders equals the total quantity sold by traders. However, a difference is that normal order-driven markets would choose the clearing price in order to maximize the traded quantity, while in a crossing network the allocation is constrained by that the clearing price is set by an external market, and that only orders that are willing to trade at this external price are accepted. This constraint often results in a lower traded quantity. Due to this constraint it is possible, or even likely, that the marginal price of a particular item would differ for sellers and buyers.

Crossing networks are often call markets with a single bid round, but some crossing networks operate continuously. For a bidder, one advantage with crossing networks is that it becomes possible to trade large quantities, block orders, with less influence on market prices. This is for example attractive for institutional investors. Crossing and crossing networks are discussed in more detail by Harris (2003). U.S. Pat. No. 8,131,633 by Schlifstein and David presents embodiments of crossing-networks that are compatible with Regulation NMS in U.S.

Normally rule-based exchanges with continuous trading would use discriminatory pricing to set transaction prices. An old order, which was submitted or activated some time before being accepted, is normally transacted at a price equal to its limit price. A newly submitted or newly activated order is transacted at the price that is set by old orders that it is matched with. Sometimes a new order with a large bid quantity could be matched with several small old orders with different limit prices. In this case, the new order would be divided into parts that are transacted at different prices. Pricing rules of rule-based exchanges are discussed in more detail by Harris (2003).

The Resource Allocation Design by DeMartini et al. (1998) and iBundle by Parkes (1999) both allow bidders to make bids on bundles and payments are discriminatory in both auctions. U.S. Pat. No. 7,133,841 by Wurman and Wellman present a range of methods that can be used to set prices in such auctions. U.S. Pat. No. 7,870,060 by Barker, Co and Grannan present networks, systems and methods that match orders for bundled financial instruments. U.S. Pat. No. 7,124,106 and U.S. Pat. No. 6,035,287 by Stallaert, Whinston and Will allow market participants to exchange bundles of assets, including assets in different asset classes. A bundle of assets to be traded is entered, wherein proportions of each asset to be traded in units of a specified bundle size are provided by the market participant. Assets to be acquired by one market participant are matched against the same asset which other market participants are seeking to dispose. A market participant may enter multiple bundles, and may specify substitutability among bundles by entering one or more portfolio constraints.

U.S. Pat. No. 7,840,447 by Kleinrock and Cao present methods for pricing and auctioning bundled items among multiple sellers and buyers, for on-line shopping applications. This pricing step addresses a combinatorial optimization problem, which is called “bin packing pricing with an approximate membership”.

Clock auction versions of the Vickrey auction (and other auctions where the transaction price of accepted bids is determined by the bid price of competitors' bids) are discussed in the U.S. Pat. No. 8,447,662 by Ausubel; U.S. Pat. No. 6,026,383 by Ausubel; U.S. Pat. No. 8,335,738 by Ausubel, Cramton and Milgrom. In particular clock auctions often use a concept called “clinching”. This means that a bidder has ensured to be allocated units at the standing price before all units of the auction have been cleared. The clinched units are often transacted at the standing price, which typically is closer to the reservation price compared to the marginal price. Clinching of a bidder occurs when the auctioneer is willing to trade more units at the standing price than competitor(s) of the bidder is/are willing to trade at the standing price. The number of units clinched at the standing price is given by the number of units that the auctioneer is willing to transact at that price minus the number of units that competitor(s) of the bidder is/are willing to trade at that price. We say that the clearing is partial if the same auction makes two allocation decisions and there is at least one bidding round between the allocation decisions.

DEFINITION: We say that clearing of a package type is in one stage if the auction design is such that all bids for the package type are submitted before any allocation decisions are made for the package type.

The advantage with letting competitors' bids completely decide the transaction price of a bidder's accepted bid is that it under some special circumstances, such as in second-price auctions, Vickrey auctions and in the Vickrey-Clarke-Groves (VCG) mechanism, become profitable for a bidder to choose a buy bid or demand schedule that fully and truthfully reveals the bidder's valuation of units of an item and a sell bid or supply schedule that fully and truthfully reveals its cost of providing units of an item. Such auctions have a truth-telling mechanism, and we say that they result in competitive bids (e.g. competitive transaction schedules or lists of competitive limit orders), which makes it possible for the auctioneer to allocate items in a socially efficient way. We use the term competitive bid price to denote a bid price of a price-quantity pair in a list of price-quantity pairs in a competitive transaction schedule and/or a bid price of a limit order in a list of competitive limit orders. Some of the embodiments of the clock auctions discussed in U.S. Pat. No. 8,447,662 by Ausubel; U.S. Pat. No. 6,026,383 by Ausubel; U.S. Pat. No. 8,335,738 by Ausubel, Cramton and Milgrom have this property. Still transaction prices are generally set at a non-competitive price in auctions with a truth-telling mechanism, as the transaction price of an accepted bid is normally set by rejected bids of the competitor(s), which typically are closer to the reservation price compared to the marginal price. Core-pricing and generalized second-price auctions are normally not truth-telling mechanisms, but they can be truth-telling mechanisms under some very special circumstances.

An auctioneer often decides the auction format in order to maximize its own surplus or to increase the surplus of its clients, the bidders. Normally, the auctioneer wants bidders to bid competitively or nearly competitively, which also makes the auction outcome more efficient for the society as a whole. In double auctions, more competitive bids will normally increase the transacted quantity.

In addition to receiving competitive bids, an auctioneer that procurers or sells one or more items would normally also prefer the transaction price to be equal to or close to the marginal bid. In practice it is difficult to motivate bidders to submit competitive bids if the transaction price is set to equal the marginal price. The choice of auction format is also determined by the auctioneer's risk preferences. A risk-averse auctioneer may prefer an auction that gives the auctioneer a safe payoff even if it has a lower expected surplus than an auction that gives a riskier payoff. Some auction formats are chosen to deter collusion among bidders or other types of manipulations of the auction. Other considerations are transparency of the auction, fairness and the administrative or computational burden for the auctioneer and bidders.

Some auctions also have side-payments to bidders, such as up-lift in electricity markets, which is used to compensate bidders for switching costs in production costs. Sometimes there are also such payments to producers, even when they do not produce.

After an auction has been cleared there is normally a settlement procedure, which ensures that each allocated item is delivered against a payment of the transaction price.

### Rationing

Sometimes there is excess demand from buyers or excess supply from sellers at the marginal price. This for example occurs if traders are willing to buy more units of an item at the marginal price than traders are willing to provide at this price, or vice versa. This often happens for stepped bid curves, so that the transacted quantity of a bidder is not uniquely determined by the clearing price. Normally all buy bids above the marginal price and all sell bids below the marginal price are accepted, while bids at the marginal price are rationed. This is called rationing on the margin.

In practice, pro-rata (proportional) rationing on the margin is normally used in static (sealed bid) multi-unit auctions. Dynamic auctions often give priority to the bid that arrives first (time-priority). Sometimes marginal bids are rationed by some random method. A random method would for example make sense in a single object auction, where it is not possible to divide the traded object between a plurality of bidders.

The patent application US 2016/0232603 by Holmberg et al. and an academic paper Holmberg, which is to be published in Economic Journal, discuss various rationing rules and how they can be implemented. They, for example advocate a rationing rule where rationing is disproportionate on the margin and where the disproportionality of the rationing rule depends on the marginal price. They recommend that a rationing rule should give priority to bidders with large quantity increments far from the reservation price and to bidders with small quantity increments near the reservation price, as this will normally result in more competitive bidding.

U.S. Pat. No. 8,447,662 by Ausubel briefly discusses rationing rules for combinatorial clock auctions, such as time priority and proportional rationing. But note that this patent calls it a “reduction rule”. Also note that clock auctions as discussed in U.S. Pat. No. 8,447,662 often start with a price at or near the reservation price. Due to the activity/monotonicity rule, the bid quantity will then normally decrease as the price then moves further away from the reservation price. In this specification, we instead use the convention that a bidder's bid prices are sorted, in reverse order, with respect to the distance to the reservation price, such that the bid price closest to the reservation price comes last. Thus a quantity increment at a bid price in our presentation corresponds to a quantity decrement at a price in U.S. Pat. No. 8,447,662. Peke and Rothkopf (2000) present a general time-priority rule that can be used in combinatorial auctions. U.S. Pat. No. 6,026,383 by Ausubel mentions a random method as an example of a rationing rule (method of breaking ties). Peke and Rothkopf (2003) discuss random methods for combinatorial auctions.

The scientific publication by Kremer and Nyborg (2004) also show that bidding can sometimes be made more competitive if not only bids at the margin are rationed. They propose that infra-marginal quantities should also be rationed proportionally. However, rules that do not ration on the margin can result in significant allocative inefficiencies, also in a perfectly competitive auction, where all bidders bid their true values or true costs. Rather than accepting 50% from a low cost plant and 50% from a high cost plant in a procurement auction, it would obviously be more efficient to accept everything from the low cost plant, if possible. McAdams (2002) gets similar results to Kremer and Nyborg (2004) without rationing infra-marginal quantities by introducing an extra payment to rationed bidders. On the other hand such a payment reduces the payoff of the auctioneer for given bids.

Gresik (2001) discusses rationing rules in treasury auctions of the European Central Bank (a seled bid auction). He refers to pro-rata on the margin rationing as Q-rationing. He also discusses another rationing rule, c-rationing, where rationing is disproportionate on the margin in a special way; the marginal quantity increment of a bidder is (when possible) accepted in proportion to the infra-marginal volume that a bidder wants to trade at the marginal price.

Yago Saez, David Quintana, Pedro Isasi and Asuncion Mochon (2007) analyse rationing in a clock auction with a truth-telling mechanism. This type of auction is often referred to as an Ausubel auction. The four authors evaluate three rationing rules by running computational experiments. One is the standard pro-rata on the margin rationing rule, which they refer to as proportional rationing (PRR). The spread rationing rule (SRR) gives more priority to bidders with small infra-marginal quantities and the concentrate rationing rule (CRR) gives more priority to bidders with large infra-marginal quantities. The two latter are examples of rules with disproportionate rationing.

Dynamic auctions, especially auctions with continuous bidding, sometimes use time priority to ration marginal bids. In financial markets, this is often referred to as price-time priority, i.e. bids are first sorted with respect to the price. Bids with the same price are then ranked with respect to time of arrival. Time priority is a question of fairness, but it is also a way to encourage bidders to submit bids as quickly as possible, which improves liquidity. IEX, an alternative exchange in U.S., uses price-broker-time priority. In our context this would be price-bidder-time priority, if the broker is considered to be a bidder. This means that marginal sell and marginal buy bids from the same bidder are cleared before giving priority to bids with time-priority. The purpose with this type of rationing rule is to encourage brokers to submit all of their bids to IEX instead of crossing orders in-house. Some exchanges use public order precedence, which gives public marginal orders priority to marginal bids from members of the exchange, even if a member submitted a marginal bid before a public marginal bid. This is to weaken informational advantages that members often have compared to the public. U.S. Pat. No. 8,751,369 by Monroe discusses exchanges where the priority of bids can be modified, for example if a bidder pays a fee to be given a higher priority. Markets often give priority to displayed marginal bids relative to non-displayed marginal bids, in order to encourage bidders to announce their bids. Some exchanges allow bidders to specify that the whole bid, or a minimum part of it, must be accepted at the same time. Bidders use such size restrictions to avoid multiple fixed costs, including exchange fees, settlement fees and the cost of accounting for each trade. Producers in electricity markets sometimes use such bids to avoid situations where it needs to start up a plant (a fixed cost) only to produce a minor output. Bids with such size restrictions often get lower priority in the rationing process, as they are harder to execute. Large block orders that have been matched by a broker outside the exchange (crossing), often get priority in the rationing process of an exchange if the exchange requires that such matched orders have to be printed. In such cases, U.S. equity exchanges often give priority to crosses involving matched orders in excess of 25,000 shares. Thus rationing could be disproportionate for orders matched outside the exchange. In exchanges this is referred to as a size precedence rule.

Some exchanges use pro-rata on the margin rationing. A scientific paper by Field and Large (2012) empirically analyses differences in bidding behavior for standard pro-rata on the margin and price-time priority rationing rules, and they find that the rationing rule has an impact on bidding behaviour.

In theoretical models of auctions, such as in the scientific papers by Deneckere and Kovenock (1996), Fabra, von der Fehr and Harbord (2006), Simon and Zame (1990), Jackson and Swinkels (1999), it is for academic purposes (to simplify proofs for theoretical models) sometimes convenient to consider type dependent rationing rules, where for example priority is given to the most efficient marginal bids, e.g. marginal sell bids with lowest cost or marginal buy bids with highest valuations. However, such rationing rules are difficult to apply in practice, where bidders' true costs or true values are normally not observed by the auctioneer.

The accepted volume from a bidder's marginal bids often depends on the rationing rule. Still, if one side of the auction is perfectly inelastic with respect to the price, then the aggregated transacted quantity for all bidders is normally the same for given bids, irrespective of the rationing rule. However, this is not necessarily true in double auctions or in one-sided auctions where the auctioneer's demand or supply depends on the price. In this case, both the sell side and buy side of the auction could have a quantity increment at the marginal price. This means that the aggregated supply curves and aggregated demand curves from traders could intersect in an interval of quantities, so that also the aggregated transacted quantity needs to be specified by the rationing rule. We use the term “interval of” in a general way. Formally speaking an interval of quantities could be a “set of quantities” if quantities are only defined at discrete points, such as at permissible quantity levels. Note that aggregated supply curves and aggregated demand curves from traders also include the auctioneer's supply and demand curves, respectively, if any.

A rationing rule of a double auction would normally maximize the aggregated transacted quantity at the marginal price. Thus as long as there is a sell bid with a price limit at the marginal price, then this bid would be accepted as long as there is a remaining buy bid with a price limit at the marginal price (or higher).

### Disclosure of Information

One advantage with auctions with multiple bidding rounds is that the auctioneer can choose to disclose information from previous bidding rounds, such as bid data or aggregated bid data. This helps bidders to estimate the cost/value of traded items. This price discovery process tends to result in more socially efficient auction outcomes, i.e. a more optimal allocation of traded one or more units among the auctioneer and bidders. Thus one or more units sold to bidders are to a larger extent assigned to bidders that value them most, and one or more units bought from bidders are to a larger extent bought from bidders that have the lowest cost of providing them. However, as discussed by Klemperer (2004) in his book “Auctions: Theory and Practice”, feedback about competitors' bids can also increase the risk for collusion among bidders, which could result in less efficient auction outcomes.

U.S. Pat. No. 8,335,738 by Ausubel, Cramton and Milgrom discusses information that an auctioneer may want to disclose in a clock auction and U.S. Pat. No. 8,489,493 by Nager discusses information that exchanges may want to disclose to bidders. In some exchanges and auctions, a bidder can choose to partly or completely display an active order to other bidders, or to hide it from them. Some exchanges do not display any active orders. Sometimes such exchanges are referred to as dark pools. This is an advantage for institutional investors and others who want to anonymously trade large quantities without leaking information to the market. Crossing networks are sometimes organized as dark pools with none or little displayed information.

Banks et al. (1989) proposed an iterative mechanism, called the Adaptive User Selection Mechanism (AUSM), that allows bundle bids. AUSM posts the current best allocation on a bulletin board visible to all of the participants. To become part of the current best allocation, a new bid has to offer more than the sum of all of the bids it displaces. Bids that are not part of the best allocation are posted in a publicly-displayed standby queue designed to facilitate the coordination of two or more smaller bidders combining on a new bid large enough to displace a larger bidder.

At the end of the auction, it is often the case that the auctioneer announces information which makes it possible for a bidder with a losing bid to verify why its bid was not accepted.

### Bundling of Traded Items

With bundling we mean that several goods are traded as one combined product. Many industries are engaged in this practice, including telecommunications, financial services, health care and information (Adams and Yellen, 1976). A software bundle might include a word processor, spreadsheet, and presentation program into a single office suite. The cable television industry often bundles channels into a single tier. Lancaster (1966) argues that all or most goods contain underlying characteristics. For example, the cocktail Bloody Mary is a good that contains vodka, tomato juice and various spices. However, starting with a Bloody Mary, it would be difficult to separate its contents and to allocate them separately. Thus in this specification a Bloody Mary would not be considered to be a package that contains a plurality of underlying item types.

Most firms are multi-product companies faced with the decision whether to sell products or services separately at individual prices or whether combinations of products should be marketed in the form of “bundles” for which a “bundle price” is asked. Price bundling plays an increasingly important role in many industries (e.g. banking, insurance, software, automotive) and some companies even build their business strategies on bundling. Often companies sell a package or set of goods or services for a lower price than they would charge if the customer bought all of them separately. Pursuing a bundle pricing strategy allows a firm to increase its profit by giving customers a discount. Venkastesh and Mahajan (2009) has written a review that discusses how bundling is used in practice and that summarizes the academic literature on bundling.

Pure bundling occurs when a consumer can only purchase the entire bundle or nothing, mixed bundling occurs when consumers are offered a choice between purchasing the entire bundle or one of the separate parts of the bundle.

Pure bundling can be further divided into two cases: in joint bundling, the two products are offered together for one bundled price, and, in leader bundling, a leader product is offered for discount if purchased with a non-leader product. Mixed-leader bundling is a variant of leader bundling with the added possibility of buying the leader product on its own.

Lancaster (1966) considers bundles of underlying goods, where both bundles and underlying goods are divisible, and where the number of bundle types is the same as the number of good types. He shows that the profit and the allocation of the underlying goods of a price-taking agent do not depend on how goods are bundled. Carvajal et al. (2010) prove a similar result for a monopolist. Carvajal et al. (2010) also identify circumstances where partial bundling, i.e. where traded bundles span a restricted set of the underlying goods, can be profitable for the monopolist. Otherwise the literature on bundling tend to focus on indivisible bundles and how they can be used to increase the payoff of sellers. Adams and Yellen (1976), Schmalensee (1984) and McAfee et al. (1989) analyse a multiproduct monopoly that uses indivisible bundles to price discriminate between buyers. Whinston (1990) and Nalebuff (2004) show how a multiproduct monopoly can use indivisble bundles to deter entry in one of its markets. Economides (1989), Kim and Choi (2015) and Zhou (2017) analyse multiproduct oligopolies selling indivisible bundles. Kobayashi (2005) surveys the literature on bundling of commodities and discusses policy for how bundling should be regulated in markets.

Goods could be substitutes or complements for consumers and it could be cheaper to produce a bundle of products together than to produce each one independently. Thus a bidder's optimal bid for one type of item could be related to acceptance of bids for other items. This creates an exposure problem (Rothkopf et al., 1998). As an example, suppose a bidder wants to win good A or good B, but not both, then it could be forced to bear the risk of winning only one good or bid over-cautiously. Thus to make the outcome of an auction efficient, it is sometimes preferable that a bidder could make a bid for every possible bundle (every possible combination of goods). However, as observed in U.S. Pat. No. 7,742,971 by Sandholm and Conen, the number of combinations of goods grows exponentially with the number of traded goods. Peke and Rothkopf (2003) give the example of a spectrum auction that trades 12 frequency licenses, which gives 2¹²−1=4095 combinations, and ask the question: how should 4095 different valuations be elicited from a telecom executive? In practice, it can obviously become too time-consuming and/or too costly for a bidder to submit a large number of bids when the number of traded goods is large. Sandholm and Conen therefore present an algorithm where the auctioneer iteratively interacts with the bidders and in each step the auctioneer limits bids, flexible bid information and related information to bundles that the auctioneer finds are of most relevance when clearing the auction efficiently. The received information is then used to narrow down the set of potentially desirable allocations. Similarly, Rothkopf, Peket and Harstad (1998) suggest that communication burdens can be mitigated by limiting the structure of biddable combinations. Alternatively, Peket and Rothkopf (2003) recommend that combinatorial auctions should take particular care in providing tools that help bidders in bid preparation. In particular, bid submission should not be burdensome and feedback has to be easily understandable.

### Diagonalization of Matrices

Some embodiments discussed in this application make use of some matrix algebra results, which are introduced below. Matrix diagonalization is the process of taking a square matrix and converting it into a a diagonal matrix that shares the same fundamental properties of the original symmetric matrix.

The following is known from the eigen decomposition theorem. Let R be a matrix of eigenvectors of a given square matrix M and let D be a diagonal matrix with the corresponding eigenvalues along the diagonal. Then, as long as R is a square matrix, M can be written as an eigen decomposition:

M=RDR⁻¹,

or equivalently,

D=R⁻¹MR.

Thus R and its inverse R⁻¹ can be used to diagonalize M. Furthermore, if M is symmetric and elements of the matrix are real numbers, then the columns of R are orthogonal vectors. In case the orthogonal vectors are normalized and have unit length, they are said to be orthonormal. In this case R⁻¹=R^{T}, the transpose of the matrix R. Thus the columns of R^{T} are equal to the rows of R. In this case we have:

D=R^{T}MR.

Assume that M is a positive definite matrix, then a matrix R can normally be found such that M and another symmetric matrix N are simultaneously diagonalized, i.e. D₁=R^{T}MR

and

D₂=R^{T}NR,

where D₁ and D₂ are both diagonal matrices. This result is for example presented in the book “Matrix Analysis” by Horn and Johnson (1990). This textbook and similar textbooks also present how a matrix R that simultaneously diagonalizes two matrices N and M can be found.

Under special circumstances, when matrices are diagonalizable and commute, one can find a matrix R that simultaneously diagonalizes three or more matrices. For other circumstances, there are available methods that have been presented in academic papers that can simultaneously approximately diagonalize several matrices. One such example is “A Bayesian Approach to Approximate Joint Diagonalization of Square Matrices” by Mingjun Zhong and Mark Girolami (2012). Another such example is the paper “Scaling Up Simultaneous Diagonalization” by Kuleshov, Chaganty and Liang. We say that such methods approximately jointly diagonalize a plurality of matrices. If a method simultaneously diagonalize at least two matrices then we also say that the method approximately jointly diagonalize a plurality of matrices.

Ideally, diagonalization should result in a matrix where off-diagonal elements are zero. A matrix would be approximately diagonal if off-diagonal elements are close to zero. More specifically, we say that a matrix is approximately diagonal if the absolute value (modulus) of off-diagonal elements is on average less than 10% of the average of the absolute value of diagonal elements.

In practice, matrix diagonalization has been used in principal component analysis (PCA), which is a data analysis method. PCA sometimes uses a dimensionality reduction approximation, which means that data can be approximately explained with less variables. This is useful when visualizing and processing high-dimensional data sets. Another application of PCA is when separating sources when a set of sensors measure a linear mixture of several sources. U.S. Pat. No. 7,571,130 by Weber et al. presents a hedging technique for exchange traded mutual funds. They present multi-factor risk models that can be used to construct a hedging portfolio of such funds. Their analysis makes use of PCA analysis to reduce the number of components in the multi-factor risk model. There are also non-linear PCA techniques and non-linear dimension reduction techniques. The latter are for example often applied in image processing, such as in U.S. Pat. No. 9,256,966 by Jacobs and Akhbardeh.

The paper “Scaling Up Simultaneous Diagonalization” by Kuleshov, Chaganty and Liang discusses other applications of simultaneous diagonalization, including machine learning.

### Multiprocessor Computer Systems

Multiprocessor computer systems are relevant for some embodiments discussed in this application. Examples of multiprocessor computer systems are discussed in U.S. Pat. No. 3,648,252 by Thron, Woods, Bellettiere and Stein, in U.S. Pat. No. 4,862,350 by Orr and Williams, and in U.S. Pat. No. 5,870,572 by Garcia. U.S. Pat. No. 7,801,802 by Walker, Tedesco, Van Luchene, Jorasch, and Ware presents an embodiment where a bidder sends instructions to a proxy bidder, including instructions on when a bid should be made, in a multiprocessor computer system. U.S. Pat. No. 7,197,476 by Le, Morrison, Roberts, and Wiesehuegel discusses embodiments where off increment bids are generated in a multiprocessor computer system.

### Computer-Implemented Auctions

There are many patents with details of how various auction designs can be implemented in the U.S. Pat. No. 3,581,072 by Nymyer, U.S. Pat. No. 7,792,723 by Molloy, U.S. Pat. No. 8,489,493 by Nager, U.S. Pat. No. 4,903,201 by Wagner U.S. Pat. No. 8,447,662 by Ausubel, U.S. Pat. No. 8,335,738 by Ausubel, Cramton and Milgrom, U.S. Pat. No. 6,026,383 by Ausubel, U.S. Pat. No. 7,899,734 by Ausubel, Cramton and Jones, U.S. Pat. No. 6,272,473 by Sandholm, U.S. Pat. No. 7,062,460 by Growney and Youssi, U.S. Pat. No. 8,751,369 by Monroe, U.S. Pat. No. 8,131,633 by Schlifstein and David, U.S. Pat. No. 7,010,511 by Kinney et al., and in the patent application US 2016/0232603 by Holmberg et al.

Bids could be automatically submitted from machines. U.S. Pat. No. 8,335,738 by Ausubel et al. and U.S. Pat. No. 5,394,324 by Clearwater for example discuss an air-conditioning system, where individual offices in the building automatically send bids requesting cooling services based on current reading of the thermostat and desired temperature in the office etc.

### Aspects of the Invention and its Advantages/Summary

As mentioned in the background of the specification, an item could be a package of different underlying goods, or more generally a package of different items. A part of our invention is an auction design where bundling is used to improve auction performance, for example by defining packages such that package types are approximately independent for at least one bidder near the expected marginal prices of traded packages. To get this property, it is often necessary to define packages such that each package contains several underlying items. It is sometimes necessary that a package is defined to have a negative quantity of one underlying item and a positive quantity of another underlying item. Moreover, it is often the case that package types can be made more independent if more decimals are allowed in a package's defined quantity of an underlying item. One advantage with having package types that are approximately independent is that the auction process can potentially be executed in parallel for different package types. Independence could also simplify the bidding process, the verification that bids comply with a bidding format, clearing of the auction and presentation of information to traders. In an exemplary embodiment of our invention, the auction design is implemented on a computer system with an auction computer that for example manages clearing of the auction and at least one bidder computer that for example receives bids from a bidder. In an exemplary embodiment the computer system is a multiprocessor computer system with error control of submitted bids. Error control reduces the risk for misunderstandings due to influence from noise etc. In an exemplary embodiment, the multiprocessor computer system allows parts of the auction process to be executed in parallel.

Most aspects of the invention mainly applies to auctions that trade a plurality (two or more) of types of underlying goods, or more generally two or more types of items. In such auctions, we for example suggest that the auction can trade packages of underlying goods/items, such that at least one package type sometimes contains two or more types of underlying goods/items. The advantage with this is that the volume/quantity of each type of underlying good/item in each type of package can be chosen such that packages are approximately independent for at least one trader at a particular vector of prices or for a region of prices. One method of finding such packages is related to the diagonalization of matrices, which we have discussed earlier in this specification. In order to ensure approximate independence of packages in a wider region of prices, it could sometimes be useful to let package definitions be non-linear, for example in the sense that the definition of packages depends on the price level and/or the traded volume. Alternatively, the auction could have more package types than there are underlying goods/items. In this case, a trader can bid for a subset of these packages for one region of prices, for which the subset packages are approximately independent, and then bid for another subset of packages for another region of prices, for which the other subset of packages is (approximately) independent. Independence of packages means that one or more stages of an auction can consider the packages separately, and this can improve the auction process in several ways. Alternatively, under some circumstances, it could also simplify the auction process to trade less package types in the auction than the number of underlying item types. FIG. 57 illustrates such a package definition, where each geometrical symbol illustrates a good type or item type. In FIG. 55, the number of package types equals the number of underlying good types. FIG. 56 illustrates a case where there are more package types than there are underlying good types.

In some aspects of our invention, packages would be statistically independent in the sense that the prices of package types are (approximately) uncorrelated. We say that prices are approximately uncorrelated in an auction if there is a subset of package types with at least 80% of the traded package types and at least two package types, such that there is no pair of different package types in that subset for which the absolute value of the correlation coefficient for prices of the pair is larger than 0.1.

It becomes easier for bidders to make bids for independent package types. For independent package types, it is normally sufficient for a bidder to condition transactions of one type of package on the price of that package, so there are less relevant price combinations to consider. If multiple units (or fractions) are traded for each package type, this simplification could for example mean that a bidder can express its preferences with a set of univariate transaction schedules, one univariate transaction schedule for each type of package, instead of a set of multivariate transaction schedules. This simplifies the submission of bids, for example in a multi-bid round, without (significantly) constraining a bidder's possibility to express its preferences.

One advantage with having independent package types is that it becomes easier for an organization to perform its operations in parallel, because it makes it easier for a trading person and/or trading algorithm to focus on one package type. This person or algorithm could for example manage bids for only one package type and focus on market information for that package type. This would be an advantage, for example when markets move fast.

In general, bidding formats that are known for one type of good are straightforward to apply to multiple types of (approximately) independent packages, as one can treat independent package types separately. As an example, activity/monotonicity rules can be significantly simplified if package types are approximately independent for a bidder. If package types are considered independently, an example of a simple rule that could be applied is to say that each univariate transaction schedule must be monotonic, i.e. a bidder is not allowed to submit bids that indicate that the bidder is willing to trade less of a package type at a unit price closer to the reservation price; bidders cannot offer to sell more of that type as its price decreases or offer to buy more as its price increases.

As discussed in the patent application US 2016/0232603 by Holmberg et al., aspects of the bidding format, such as the magnitude of tick-sizes and lot-sizes, can for example be used to influence market depth, transaction costs and market competitiveness. In an auction that trades multiple (two or more) types of packages, it is easier for an auctioneer to estimate the effect of such measures when packages are (approximately) independent, so that measures taken for one type of package has little influence on the trading of other types of packages. Especially as there are no studies, which we are aware of, that have analysed how aspects of the bidding format influence market depth, transaction costs and market competitiveness etc. in an auction/exchange trading multiple types of items that are not independent for traders. Thus packages that are (approximately) independent for traders in a relevant price region means that it is easier for an auctioneer to choose and up-date tick-sizes and lot-sizes—including non-constant tick-sizes and lot-sizes—optimally in that price range. For similar reasons it is easier for an auctioneer/auction computer to estimate optimal standing prices for each package in the next round of a clock auction if packages are approximately independent of each other. Similarly, in multi-period auctions where bidders explicitly choose bid prices, it is easier for a bidder to estimate optimal bids for different package types, if those packages are approximately independent, so that the bidder can make a separate decision for each package type.

One aspect of our invention is that it is often possible to convert bids for items of different types to new bids for packages of such items. Such a transformation is for example of interest if defined packages are approximately independent for a trader or a group of traders in a relevant price range. We refer to this as an independence transformation. In general, a independence transformation can transform prices and quantities associated with a set of items into corresponding prices and quantities for the defined packages. Thus this type of transformations can also be used to transform marginal prices, transaction prices, allocated quantities, permissible prices and permissible quantities for items into corresponding prices and quantities for defined packages. One can also perform an inverse independence transformation, where one starts with packages that are approximately independent for a trader or a group of traders and then transforms those packages and associated prices and quantities to new definitions of packages and new prices and quantities that are associated with those new packages, where (for example) each new package type may contain only one type of good or item. Thus, to simplify the bidding process, a bidder could submit bids associated with a particular package definition, for which packages are independent or almost independent of each other from this particular bidder's perspective in a relevant price range. Next one can use an inverse independence transformation, so that these submitted bids can be converted into new bids that correspond to package definitions used in the clearing stage of the auction.

Another aspect of our invention is that definitions of the packages could potentially improve or simplify the presentation of information disclosed by the auctioneer, such as transaction schedules, parts of transaction schedules or aggregations of transaction schedules across all or a subset of traders. Before an auction starts, an auctioneer may for example want to disclose its willingness to trade considered package types, which would often be easier if considered package types were independent. For example it is often easier for bidders to interpret a set of univariate transaction curves of the auctioneer, one univariate curve per package type, in comparison to a set of multivariate transaction curves, one multivariate curve per package type. Similarly, the auction may want to disclose information related to bids/transaction schedules that have been received in previous bidding rounds, before continuing with the next bidding round or after closing the auction. Again, such information would often be easier to interpret by bidders for independent package types, for which a set of univariate transaction curves are sufficient. It can be informative to disclose univariate curves, even if packages are only approximately independent. Thus independence transformations could be useful when presenting information to traders, and/or to supervisors of the auction process. Definitions of packages could also differ between bidding rounds in the same auction and definitions of packages could differ between traders, for example when they submit bids or when they receive information from the auction. This also means that package definitions of relevance to a trader could be part of the disclosed information to that trader.

Normally the auctioneer would define package types used in the auction, but there can be exceptions. A bidder would often have more information about its own preferences and if it knows package definitions for which it is independent, then there could be advantages with letting each bidder define its own packages of items that are to be traded and to let the bidder submit bids for such packages. In such cases, the bidder would normally also send information to the auctioneer about the package definitions that it has been using. Alternatively, a bidder would manage bids for approximately independent package types, and then an inverse independence transformation would transform those bids into bids for the underlying goods (or items) before they are submitted to the auction. Similarly, market information for underlying goods (items) from the auction could be transformed, by an independence transformation, into market information for package types before it is presented to the bidder.

For some aspects of our invention and for some circumstances, approximate independence of packages for relevant traders can only be established in a narrow price region. For some, perhaps even most, cases approximate independence of packages is mainly critical around the clearing price (marginal price) for each package type. Thus auction performance can improve if the auction process becomes better at predicting the clearing price for each type of package. Whenever predictions of the clearing prices are up-dated, it can also be desirable to up-date package definitions. This may for example occur before the first bidding round, between bidding rounds, or after marginal prices have been determined.

In general, allocation rules and pricing rules that are known for an auction with one type of good/package are straightforward to apply to an auction with multiple (two or more) types of (approximately) independent packages, as the auction can treat them independently. For example, the patent application US 2016/0232603 by Holmberg et al. discusses various rationing rules, such as time priority, broker priority, proportional rationing and various methods with disproportionate rationing. Examples of the latter are c-rationing, SRR-rationing, CRR rationing and methods where disproportionality of the rationing rule depends on the marginal price. Most of these methods are only known for auctions with one type of good/package and/or their impact on auction performance is only known for auctions with one type of package. Thus to generalize a rationing method to auctions that trade multiple types of packages or to make sure that the method has the intended impact, it would sometimes be useful to use an independence transformation, and to clear the auction and apply rationing for approximately independent packages, which could be cleared separately. After the clearing has been completed, it would sometimes be useful to use an inverse independence transformation to transform cleared allocations and marginal prices for approximately independent packages back to packages used before the clearing process and associated cleared allocations and marginal prices.

Similarly, pricing rules and their consequences for auction performance are often well-known and well-studied for auctions with one type of package. Therefore it can be preferable to calculate transaction prices for packages that are approximately independent, and treat those packages separately when clearing the auction. In case other package definitions (original packages) were used in earlier stages of the auction, one can, if desirable, use an inverse independence transformation to convert those approximately independent packages and their associated transaction prices and allocations into transaction prices and allocations associated with the original packages.

Under some circumstances it may be useful to use other types of transformations of packages. As an example, if packages are close substitutes, then traders will care less about which types of packages that they end up with and this can simplify the auction process in various ways. As an example, Klemperer's product-mix auction would sometimes perform better if package types are close substitutes. Thus it can be of interest to convert prices and quantities that relate to a particular definition of packages to new prices and quantities that correspond to a new definition of packages, where new packages are approximately substitutes/complements for a trader or a group of traders. We refer to this as a substitute/complement transformation. A transformation in the reverse direction is referred to as an inverse substitute/complement transformation.

Independence of packages for traders, or approximate independence of packages, means that package types can be managed independently in some, perhaps even all stages, of the auction process. This independence makes it straightforward to speed up these stages of the auction process, by executing these stages of the auction process in parallel for independent packages. Thus an exemplary embodiment with aspects of our invention would be implemented on a multiprocessor computer system.

Some aspects of our invention could be rather computation intensive, so probably many aspects of our invention would mainly be of interest for auctions with high-stakes, where the risk for mistakes and misunderstandings should be minimized. Thus, we believe that it will be of interest to implement aspects of our invention on computer systems where error control is used in the communication between bidder computers and the auction computer. Sometimes it would also be appreciated by the traders that all or parts of the auction's communication with bidders is encrypted.

Further applications and advantages of embodiments of the invention will be apparent from the following detailed description.

### BRIEF DESCRIPTION OF THE DRAWINGS

FIG. 1: Example of supply schedule, where supply of an item is conditional on the price of the item.

FIG. 2: Example of demand schedule, where demand of an item is conditional on the price of the item.

FIG. 3: Convex supply function for one item that depends on prices of two items.

FIG. 4: Concave demand function for one item that depends on prices of two items.

FIG. 5: Demand function for item 1 where items are independent so that demand only depends on the price of item 1.

FIG. 6: Example of an auction computer system: a network that connects an auction computer, bidder computers and an auctioneer computer.

FIG. 7: Example of components inside an auction computer, when it is a single computer.

FIG. 8: Example of components inside an computer with two CPU:s.

FIG. 9: Example of a multiprocessor computer system.

FIG. 10: Example of a distributed multiprocessor computer system.

FIG. 11: Example where two computers are connected by a communication channel with error control.

FIG. 12: Example of data stored on a data storage device of an auction computer when it is a single computer.

FIG. 13: Another example of data stored on a data storage device of an auction computer when it is a single computer.

FIG. 14: Example of data stored on a non-transitory machine readable medium.

FIG. 16: Example with bidder client program stored on a non-transitory machine readable medium.

FIG. 17: Example of data and programs stored in the memory of an auction computer.

FIG. 18: Another example of data and programs stored in the memory of an auction computer.

FIG. 19: Example illustrating that that an auction program can include several sequences of instructions.

FIG. 20: Example of auction data stored in the memory of an auction computer.

FIG. 21: Example of components inside the auctioneer computer when it is a thin client.

FIG. 22: Example of components inside a bidder computer when it is a thin client.

FIG. 23: Another example of components inside a bidder computer.

FIG. 24: Example of data and programs stored in the memory of a bidder computer.

FIG. 25: Example of structure of the auction process, some of its subprocesses and how they interact.

FIG. 26: Example of structure of the auction process, some of its subprocesses and how they interact.

FIG. 27: Example of structure of the auction process, some of its subprocesses and how they interact.

FIG. 28: Example of flow chart for a static auction.

FIG. 29: Example of flow chart for a dynamic auction.

FIG. 30: Example of flow chart for a dynamic auction where bids are cleared repetitively.

FIG. 31: Example of flow chart for a dynamic auction where the bidding format is updated.

FIG. 32: Example of flow chart for a dynamic auction where allocated items are automatically dispatched or prepared for dispatch.

FIG. 33: Example of flow chart for a simple auction process without automatic verification that bids satisfy the bidding format and without automatic information disclosure to bidders.

FIG. 34: Example of flow chart for a bidder client.

FIG. 35: Example of flow chart for a bidder client in an auction, which could have a plurality of bidding rounds.

FIG. 36: Example of flow chart for a bidder client in a dynamic auction, where bids are cleared repetitively.

FIG. 37: Example of flow chart for a subprocess where bidders input bids.

FIG. 38: Example of flow chart for a subprocess where bidders input bids.

FIG. 39: Example of flow chart for a subprocess where bidders input bids and define packages.

FIG. 40: Example of flow chart for a subprocess where bidders input bids and define packages.

FIG. 41: Example of flow chart for a subprocess that verify that transformed bids comply with bidding format.

FIG. 42: Example of flow chart for a subprocess that verify that transformed bids comply with bidding format.

FIG. 43: Example of flow chart for a subprocess that verify that transformed bids comply with bidding format.

FIG. 44: Example of flow chart for a clearing process that starts with an independence transformation.

FIG. 45: Example of flow chart for a clearing process that starts with an independence transformation.

FIG. 46: Example of flow chart for a clearing process that ends with an inverse independence transformation.

FIG. 47: Example of flow chart for a clearing process that determines marginal prices before performing an independence transformation.

FIG. 48: Example of flow chart for a clearing process that determines marginal prices before performing an independence transformation and that determines payments.

FIG. 49: Example of flow chart for a clearing process that determines marginal prices before performing an independence transformation and that ends with an inverse independence transformation.

FIG. 50: Example of flow chart of process where traders are informed of allocations and transaction prices.

FIG. 51: Example of flow chart of process that disclose information from previous bidding rounds.

FIG. 52: Example of flow chart of process that up-dates the bundling rule.

FIG. 53: Example of flow chart with post-processing of auction data, which is then presented to the auctioneer.

FIG. 54: Example of flow chart of process that includes a step where the transaction schedule of the auctioneer is disclosed.

FIG. 55: Example with three packages that each contains three types of underlying goods.

FIG. 56: Example with four packages that each contains three types of underlying goods.

FIG. 57: Example with two packages that each contains three types of underlying goods.

FIG. 58: Example with two packages that each contains two types of underlying divisible goods.

FIG. 59: Example with two packages of two underlying item types, where each item type is a package.

FIG. 60: A method for enabling a bidder to participate in an auction that trades a plurality of different item types.

FIG. 61: A method for enabling a bidder to participate in an auction that trades a plurality of different item types.

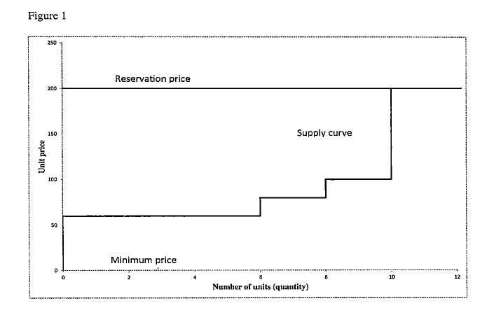

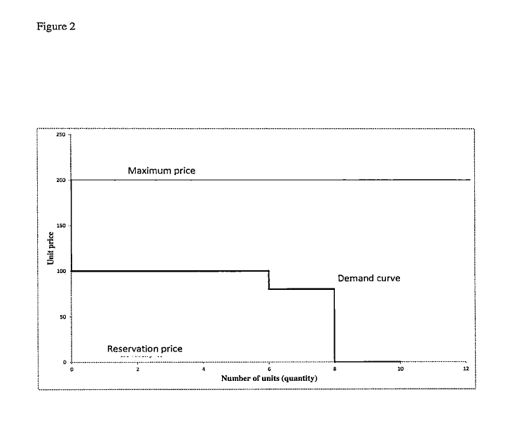

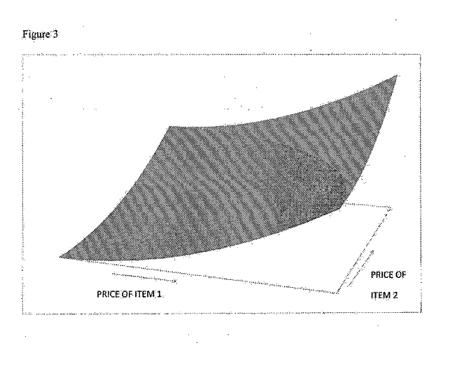

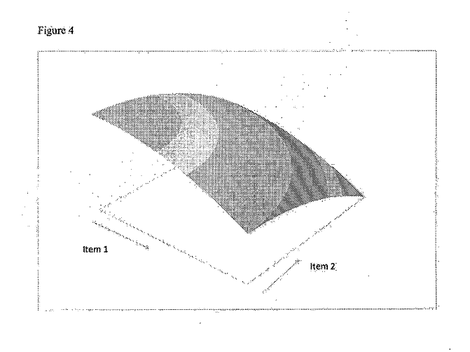

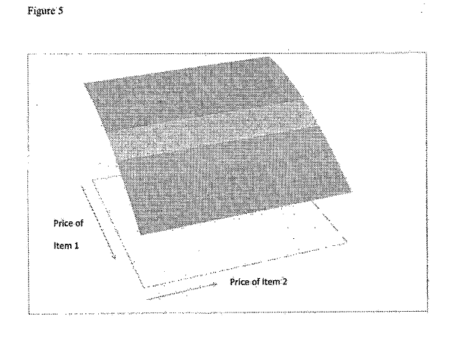

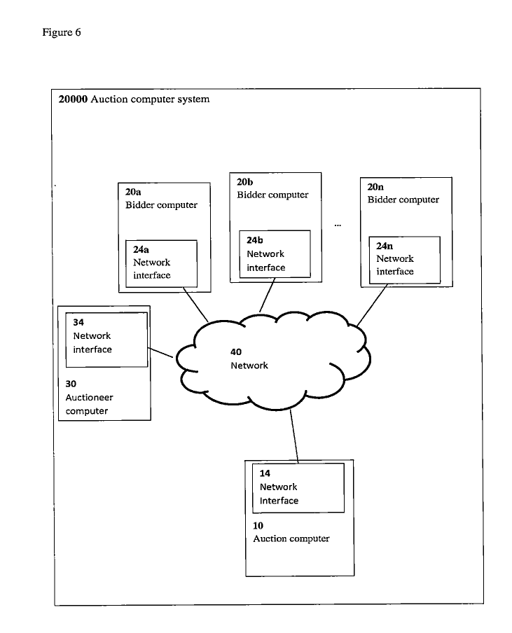

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figure

### DETAILED DESCRIPTION OF EXEMPLARY EMBODIMENTS

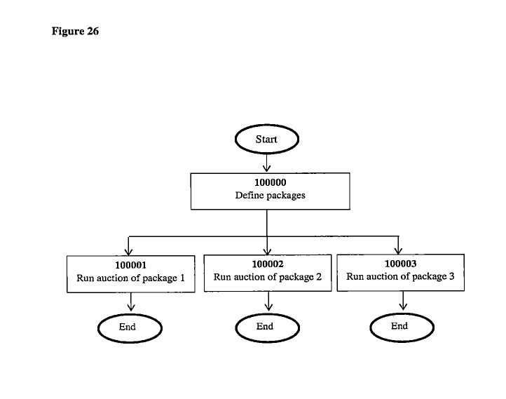

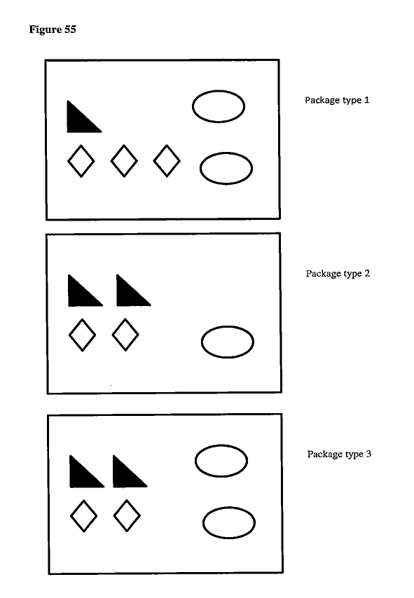

In an exemplary embodiment, the auctioneer uses an auction process that conducts a partly or fully automatic auction with aspects of our invention on behalf of the auctioneer. Aspects of our invention are mainly applicable to cases where the auction trades at least two types of items. FIG. 55 illustrates a case with three types of items, which are represented by three geometrical shapes: triangles, rombs and ellipses. The flowchart in FIG. 26 illustrates a basic implementation of how our invention can be applied to a situation where, as an example, these three item types are to be traded. In an exemplary embodiment, the first step 100000 defines packages of traded items. FIG. 55 illustrates examples of such packages, where the first package type contains 1 triangle, 3 rombs and 2 ellipses. In an exemplary embodiment, packages are chosen such that they are approximately independent for relevant traders for prices where the auction is expected to clear. As illustrated by the flowchart in FIG. 26, the auctioneer can then run separate auctions for each type of package. One advantage with this is that separate auctions can be run in parallel, which can speed up the auction process. We refer to each of the separate auctions as a subauction. A subauction for a package type could essentially have any auction design that can be used to trade one type of item, and designs could be different for subauctions trading different types of packages. A subauction for one type of package could for example be a single object auction or a multi-unit auction. It could for example be a single bidding round auction, an auction with multiple bidding rounds, or an exchange with continuous bidding. Bid prices could be implicitly or explicitly chosen by bidders. A subauction for one type of package could for example be of almost any of the auction types that are relevant for one package type, and some of them are discussed earlier in this specification. Similarly, most of the detailed embodiments of auction systems that are relevant for one package type, could also be applied to a subauction.

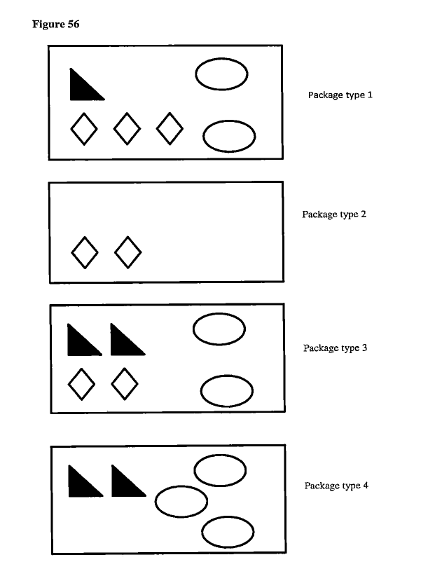

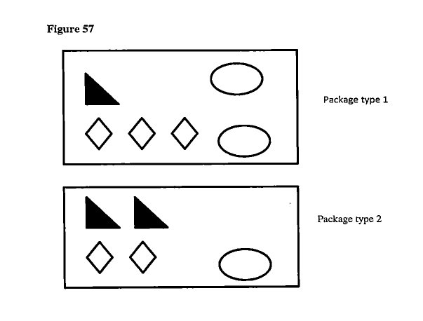

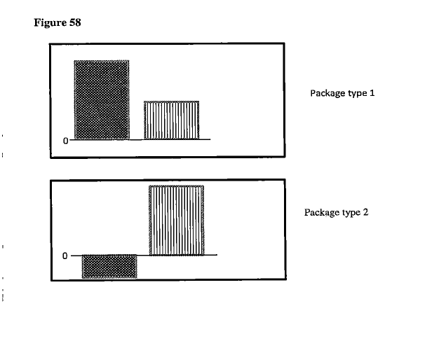

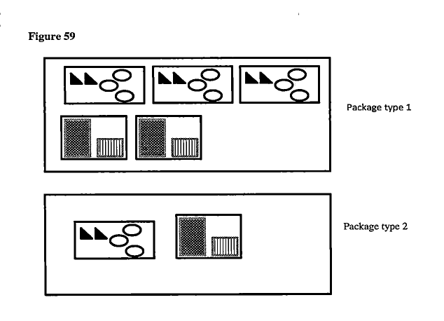

There are three types of packages in the flowchart in FIG. 26, but this is just an example. Any number of packages could be traded in a similar way. The number of defined package types could be the same as the number of underlying item types that are traded. However, there can also be advantages with having more package types compared to the number of item types. Assume that N item types are to be traded and that there are M>N package types. One reason for this could be that a subset with N of those package types are approximately independent for one bidder, and that another subset with N package types are approximately independent for another bidder. Another reason could be that a subset with N of those package types are approximately independent for a bidder in one price range, and that another subset with N package types are approximately independent for the bidder in another price range. FIG. 56 gives an example where the number of package types is larger than the number of item types. There could also be situations, where an auctioneer would prefer to have fewer package types than item types as illustrated by FIG. 57. One reason for this could be that packages are well-chosen, so that traders can express the most important aspects of their preferences, even if the number of package types is less than the number of underlying item types. For example, left shoes and right shoes could be viewed as two different item types, but given that bidders would normally want to buy them together, it would often make sense to trade them in the same package. This would correspond to a dimensionality reduction method. As illustrated in FIG. 56, a package would normally include at least one type of item, but a package may not include all of the N item types that are traded. In FIG. 58, a package contains a different volume from each of two item types, where different item types are represented by different patterns and a volume is represented by the height of a bar. This is to illustrate that the number of items in a package could be a real number or a fraction; it could even be a negative number. FIG. 59 illustrates that an item could in its turn be a package of items.

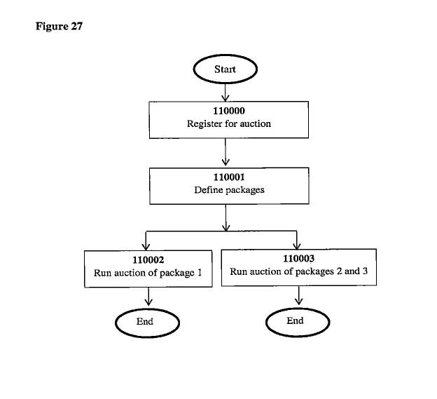

In an alternative embodiment, which is illustrated by FIG. 27, the number of parallel sub-auctions could be less than the number of traded package types. In this case, at least one of the sub-auctions would have to trade at least two package types in the same sub-auction. One reason for the organization of the auction as in FIG. 27 could be that packages 1 and 2 and packages 1 and 3 are approximately independent for relevant traders for prices where the auction is expected to clear, but packages 2 and 3 are not approximately independent for relevant traders. The embodiment in FIG. 27 has the feature that bidders register for the auction before the packages are defined. One reason for this could be that characteristics of bidders are helpful when deciding which traders are relevant for the auctioneer and helpful when defining packages, so that they preferably are independent for those relevant traders. Historical data, from previous related auctions and relevant historical market data can also be helpful when defining packages.

Embodiments with Multiple Package Types in Some Stages of the Auction

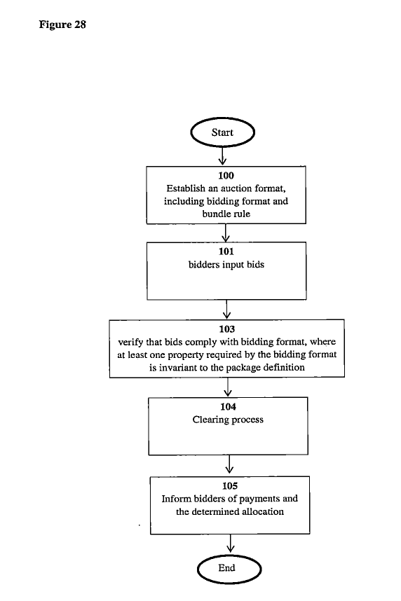

Next, we will discuss embodiments that can be useful when trading a plurality of package types in the same auction. This is for example illustrated by the flow charts in FIG. 28 to FIG. 31. We often use the term auction, but most embodiments discussed here could also be used to run a sub-auction with a plurality of package types.

The flow chart in FIG. 28 illustrates the operation of a static (single bidding round) auction. The first step 100 in the process is to initialize the auction, such as establishing an auction format, including a bidding format and definition of packages. The latter corresponds to a bundle rule. In this specification, bundle rule and definition of packages have essentially the same meaning. In an exemplary embodiment, the definition of packages would be such that some package types are approximately independent for at least one trader for some price range. Normally, this step also defines the number of units that are to be traded of each package type and characteristics of underlying items. This initial step may also involve registration of bidders and their characteristics.

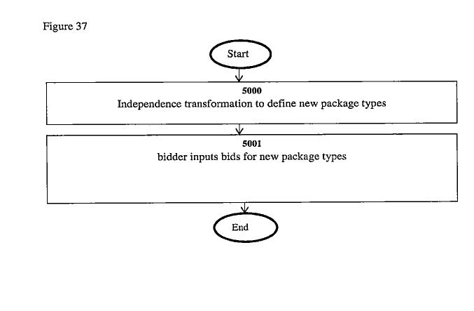

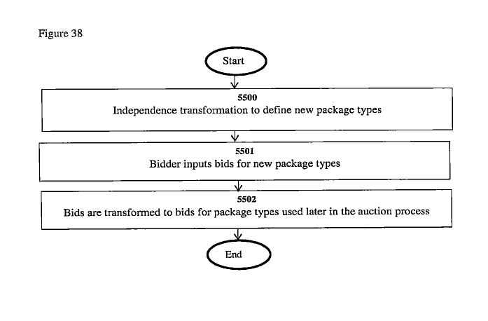

The second step (101 in FIG. 28), in the exemplified single bidding round auction is that one or more bidders input their bids, or are given an opportunity to input their bids. This step could use embodiments from prior art, but an exemplary embodiment would apply aspects of our invention. The step is simplified if bids for a package type would only be conditional on prices for that package type, and not on other package types. For a package type that a bidder finds to be approximately independent of other package types in the auction, this simplification can be introduced without significantly constraining the bidder's possibilities to express its preferences for that package type. FIGS. 37 to 40 illustrate that this step may involve several subprocesses. For example, an independence transformation could be used, as in step 5500 of FIG. 37, so that packages are approximately independent, or more independent, for a bidder in some relevant price region and/or packages are independent for more bidders at some relevant price region. An independence transformation could be the same for all bidders, but it is also possible that two or more bidders submit bids for different package definitions. If packages are independent, a bidder could express its preferences by means of a set of univariate transaction schedules, one schedule for each type of package, instead of a set of multivariate transaction schedules. This simplifies the submission of bids, for example in a multi-bid round, without (significantly) constraining a bidder's possibility to express its preferences.

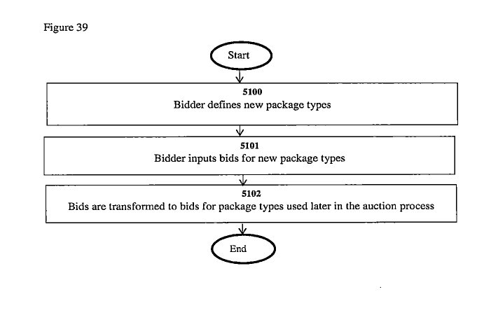

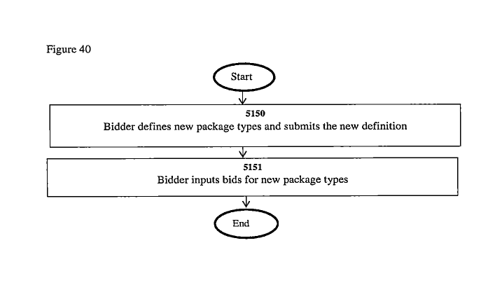

Normally the auctioneer would define packages used in the auction, but there can be exceptions. A bidder would often have more information about its own preferences and if it knows package definitions for which it is independent, then there could be advantages with letting each bidder define its own packages of items that are traded in the auction and to submit bids for such packages. Such embodiments of the bidder-input-bids-process are illustrated in FIG. 39. In case bidders submit bids for different package definitions, it could be beneficial to transform those submitted bids to new bids that correspond to a package definition that is the same for all bidders. Step 5102 in FIG. 39 could represent such a transformation. However, it can also be beneficial to wait with such a transformation to later subprocesses, or perhaps even to altogether omit such a transformation. FIGS. 37 and 40 represent such embodiments. If a bidder submits bids to the auction process for package types that the bidder has defined on its own, then it would normally be useful that those package definitions are also submitted to the auction process. Step 5150 in FIG. 40 includes such a submission of package definitions.

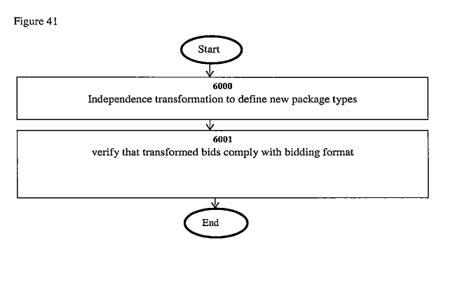

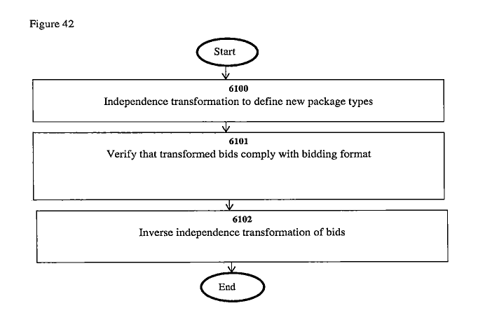

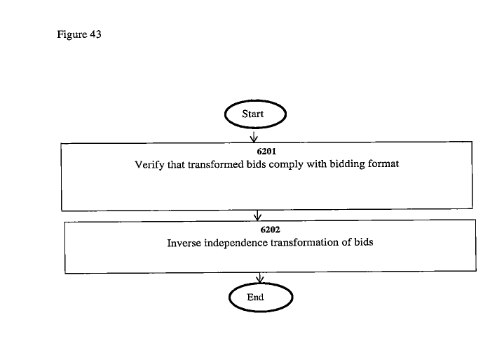

The next step 103 in FIG. 28 verifies that bids comply with the bidding format. This normally involves a verification that submitted bid prices have been selected from permissible prices, bid quantities have been selected from permissible quantities and that bids do not violate a monotonicity constraint or activity rule. The step could use embodiments that are known from prior art, but in an exemplary embodiment it would use aspects of our invention. As exemplified in FIG. 28, one or more properties of the bidding format might be invariant to the package definition. This would mean that some aspects of the bidding format would not change even if package types would be redefined. A trader's willingness to trade packages should in theory be symmetric, and this symmetry could also be enforced by the bidding format. If a bidder wants to change its transacted quantity of package X by a certain amount if the price of item Y changes by a small amount, then the bidding format could require that bidder must also change its transacted quantity of item Y by the same amount if the price of item X changes by the same small amount. Regarding monotonicity, for a bidder, for whom package types are approximately independent, it would often be sufficient to verify that bids for each package type are monotonic with respect to the price of the package. To speed up the auction process, such a verification could be done partly or fully in parallel for different bidders. In addition, the auction could also verify monotonicity of bids for different package types from the same bidder in parallel. Thus as illustrated by step 6000 in FIG. 41, an exemplary embodiment of the verify-that-bids-comply-with-the-bidding-format subprocess could start with an independence transformation to define new packages. In an alternative embodiment, the independence transformation has already been performed in an earlier subprocess, and if this information is still available, step 6000 could be omitted in the verify-that-bids-comply-with-the-bidding-format subprocess. This is illustrated by FIG. 43. The next step 6001 of the subprocess in FIG. 41 verify that bids comply with the bidding format. If a bid does not comply with the bidding format, the bidder could be informed of this and be given an opportunity to resubmit its bid, or the bid could simply be neglected. Alternatively the bid might be accepted if the bidder pays a fine. As illustrated by step 6102 in FIG. 42 and step 6202 in FIG. 43, embodiments of the verify-that-bids-comply-with-the-bidding-format subprocess could end with an inverse independence transformation of bids. As an example, if package definitions are different for different bidders when they submit bids and/or when it is verified that submitted bids comply with the bidding format, then it could for example be helpful to transform those bids so that they correspond to a package definition that is the same for all bidders in later stages of the auction.

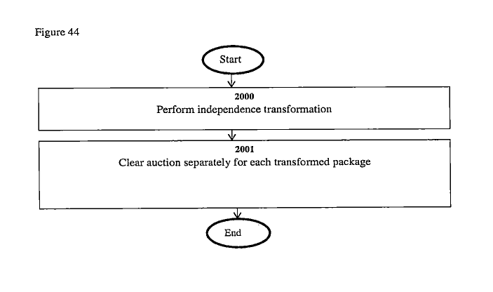

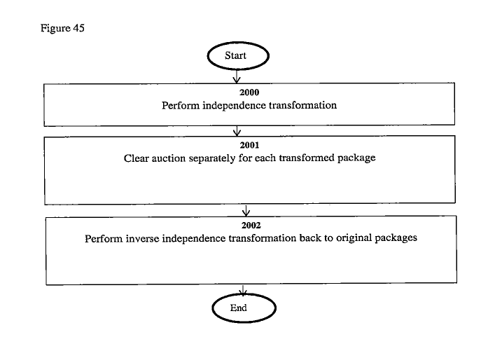

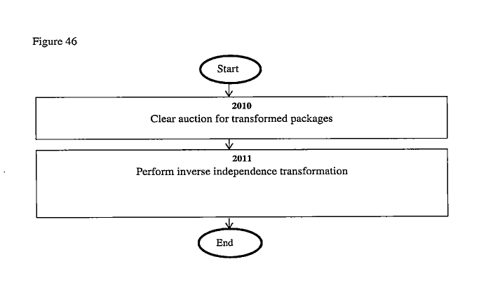

The next step 104 in FIG. 28 is a clearing process, sometimes referred to as the winner determination problem. It calculates marginal prices and an allocation of auctioned packages based on the bids that have been received from bidders. The clearing process may also determine transaction prices and payments to/from each bidder. It would be possible to use embodiments that are known from prior art in the clearing process, but exemplary embodiments of the clearing process would apply some aspects of our invention. The clearing process could for example start with an independence transformation as in step 2000 of FIG. 44. For an exemplary embodiment, packages would be approximately independent for relevant bidders and the clearing process would clear the auction separately for different packages as illustrated by the step 2001 in FIG. 44 and FIG. 45. This also means that clearing for different package types could be processed in parallel, which would speed up the auction process. Depending on the circumstances the clearing may be followed by another transformation, such as an inverse independence transformation, which for example is illustrated by the step 2002 in FIG. 45.

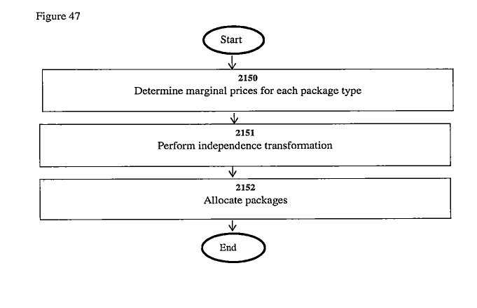

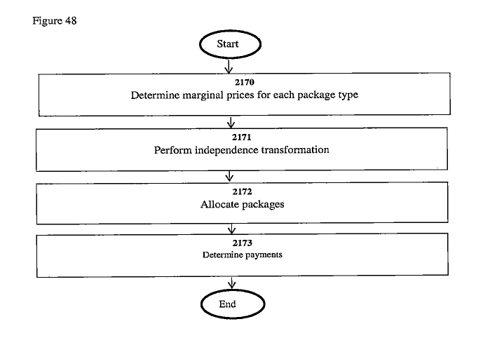

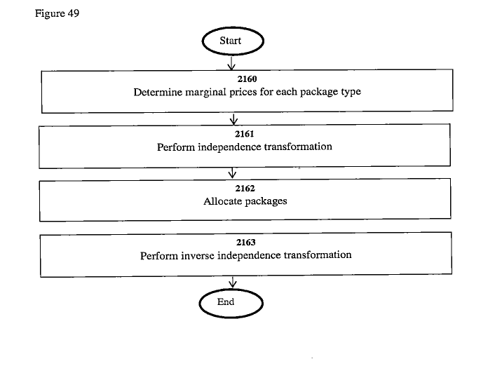

In exemplary embodiments of the clearing process in step 104 in FIG. 28, which are illustrated by FIGS. 47 and 49, transformation of bids and packages would be used as part of the rationing process. For example in order to make package types approximately independent for bidders with marginal bids, so that each package type can be rationed separately. In FIG. 47, the first step 2150 determines marginal prices for each package type. The next step 2151 performs an independence transformation. The third step 2152 determines allocations of packages to traders. This step may for example separately apply rationing rules for each package type that are known in prior art for auctions with one type of item. Depending on the circumstances, it might be beneficial to end the clearing process with an inverse independence transformation as illustrated in FIG. 49. A clearing process may also include a step where payments to sellers and payments from buyers are determined, as illustrated by step 2173 in FIG. 48. This step would also include a calculation of transaction prices. Such a calculation is for example relevant for pricing rules that are known from prior art where the transaction price of an item type could differ from the marginal price of item type. It is normally straightforward to calculate payments to/from each trader when allocations and transaction prices have been determined.

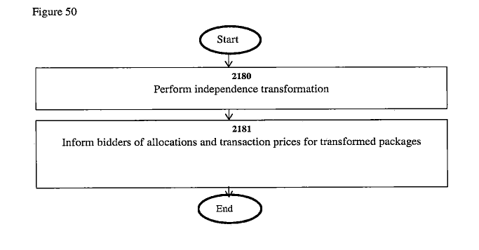

The final step 105 in FIG. 28 is to inform bidders of allocations, transaction prices and payments. This step may also include a full or partial disclosure of individual or aggregated bid data. Step 105 could be performed as in prior art. However, as illustrated by step 2181 in FIG. 50, the process in step 105 may also involve a new definition of packages and a transformation of allocations and prices to such packages. Definitions of new packages could differ between bidders. A transformation as in step 2181 in FIG. 50, could for example be an exemplary embodiment if bidders find it easier to interpret disclosed bid data for package types that are approximately independent for the bidder.

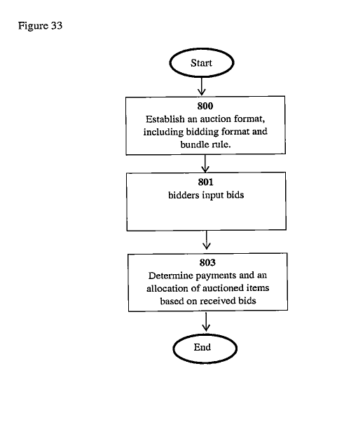

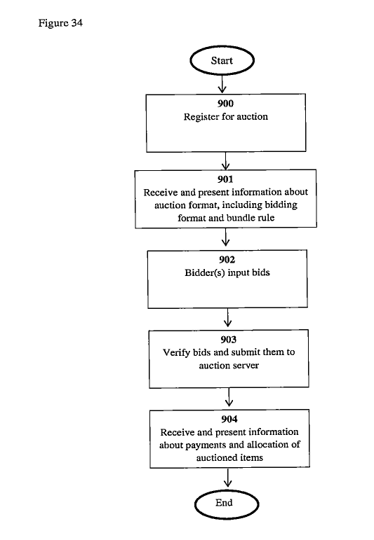

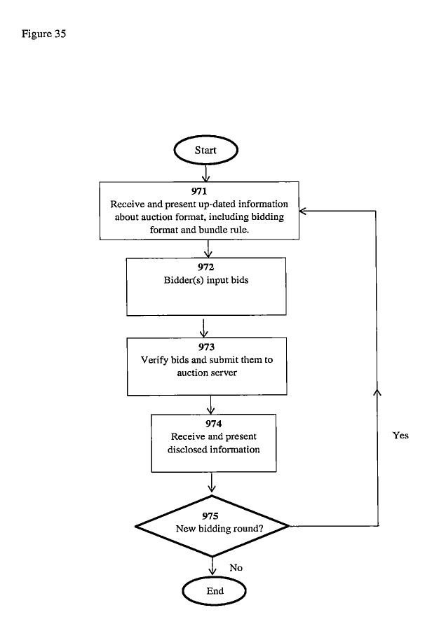

Normally, it would not be the preferred embodiment, but there could be circumstances where the automatic auction process does not disclose any type of information to bidders, including information about the final allocation. There could also be circumstances where an auctioneer prefers to keep parts of the auction design, such as the rationing and allocation rule, secret. This could for example be the case if the auctioneer has special deals with some bidders that it prefers to keep secret. Normally it is not our preferred embodiment of the auction process, but the simplest version of auction would not even check whether submitted bids satisfy the bidding format. FIG. 33 shows an example of such a flow chart for a simplified auction process. Our other flow charts of an auction process could be simplified in a similar way.

We often present sequential processes in our flow charts, but this does not rule out that some of these tasks could be conducted in parallel. This would normally speed up the operation of the auction. This would be an advantage in dynamic auctions, especially for continuous trading, such as financial exchanges, where it is sometimes critical that clearing of the auction is as quick as possible. In case of an auction with a plurality of bidders there could for example be several parallel processes, bidder clients, that manage the auction process' communication with bidders and that verifies that bids comply with the bidding format. This would primarily correspond to steps 101 and 103 in case of a single bidding round auction. This means that bids can be received simultaneously from several bidders. Parallel communication processes with bidders may not be synchronized. As an example, in case of a single bidding round auction, one parallel process could be at step 101 with one bidder while another parallel process is at step 103 for another bidder. Similarly bidding for different package types may not be synchronized, and bids for different package types could be managed in parallel.

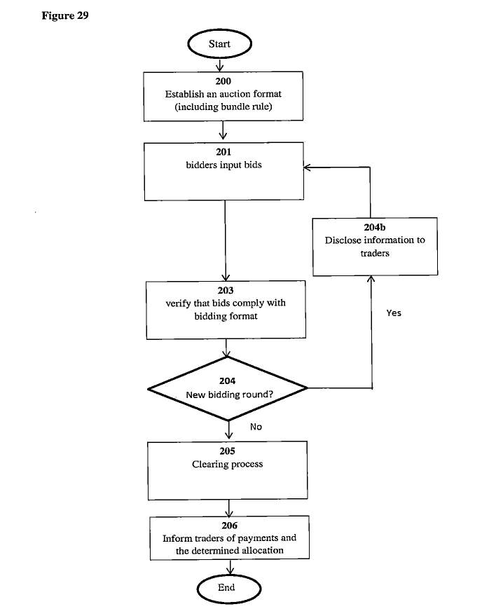

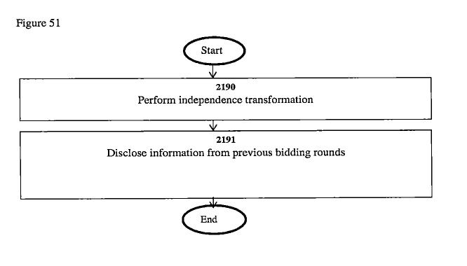

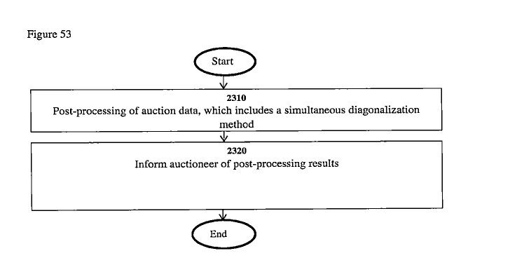

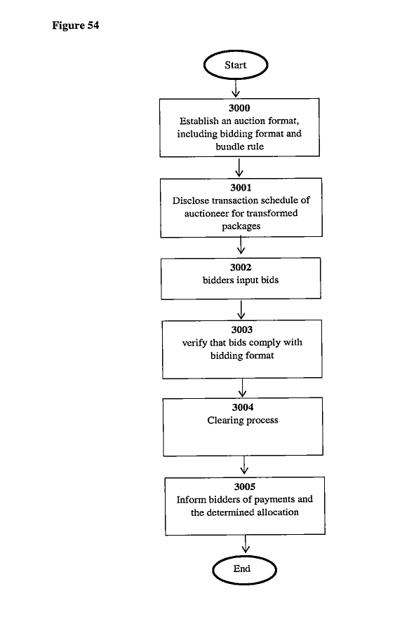

FIG. 29 illustrates the flow chart of a dynamic auction when aspects of our invention are applied to such an auction. One difference to the static (single bidding round) auction in FIG. 28 is that there is a new step 204 that checks whether there should be a new bidding round. This step could for example check whether the bids received are sufficient to clear the auction or to check whether the predetermined number of bidding rounds has been achieved. An auction may also close at a specified time. The auction process can also decide not to have additional bidding rounds if no or too few bids were received in the previous bidding round or if too few bidders submitted bids. It could also be that the auction ends for bidders that have not been sufficiently active, while other bidders can continue to bid in the new bidding round. Another difference to FIG. 28, is that we want to emphasize that when we write disclose information to bidders, then this type of information could also be disclosed to the auctioneer. Thus, we use the more general term traders in FIG. 29. If there is a new bidding round, the auction process may in step 204b in FIG. 29 choose to disclose auction relevant information to the traders before new bids are submitted in this new round. Such information could for example be characteristics of bids in previous rounds, such as all bids or aggregated bid information. As discussed earlier in the specification and in prior art, there is sometimes other information that could be disclosed. Sometimes a trader could influence what information it and/or others receive. The same information could be disclosed to all traders, or traders could get different information. In case traders would find it easier to interpret information for independent packages, it could be useful to perform an independence transformation before disclosing information. Such an embodiment of the Disclose-information process in step 204b is illustrated in FIG. 51. Next, steps 201-203 in FIG. 29 are repeated, where bidders are given the opportunity to input new bids and the auction process verifies that they comply with the bidding format. In some embodiments of step 201, bidders could also choose to withdraw, alter or cancel bids that have been submitted in previous bidding rounds. Bids may also expire automatically, for example in case they have some type of time limit. The auction is cleared in the step 205, and traders are informed of payments and allocations in the step 206. Again, the same information could be disclosed to all traders, or traders could get different information. In case traders would find it easier to interpret information for independent packages, it could be useful to perform an independence transformation before disclosing information, as illustrated in FIG. 50. The auction process may perform special post-processing of auction data, which can be useful for the auctioneer when evaluating the auction. In an exemplary embodiment, the post-processing process would involve one or more of the simultaneous diagonalization techniques that have been discussed in the specification, as illustrated by the flowchart in FIG. 53.

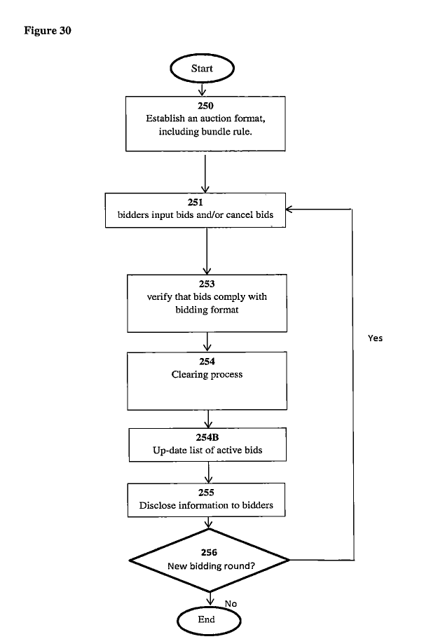

In a more general auction, the auction may determine the allocation for some units (called clinching in clock auctions), before all units have been cleared. Similarly, a repeated clearing process is often used in exchanges with continuous trading. One embodiment with repeated clearing is illustrated by the flow chart in FIG. 30 where a partial or full allocation decision could be made in step 254. After parts of a bid quantity or quantity increment have been accepted, those parts would normally be removed from the active bids. This is done in step 254B. As discussed earlier in the specification, step 254B, may also involve activation of a bid that was submitted in a previous bidding round. Activation may for example occur at a time specified by the bidder or for market conditions (such as a price level or a direction of price movement) specified by the bidder. In an alternative embodiment, active bids could instead be updated inside the clearing process. In another embodiment, up-dating of active bids may instead occur just after step 251 or as a part of step 251. Bidders are informed of the allocation in step 255. In embodiments for auctions where speed is an issue, such as for financial exchanges, allocation decisions and communication of them to bidders would in some embodiments run parallel with processes that receive new bids from bidders. Step 256 decides whether to continue the auction with more bidding rounds. The auction may stop for reasons similar to the ones discussed for step 204 in FIG. 29. Some auctions, such as clock auctions, may stop when all items that the auctioneer wanted to trade have been allocated. Similar to some existing financial markets, the auction may also decide to take a break (trading halt) in step 256, for example if there has been extraordinarily large movements in bid prices and/or clearing prices in the last round(s) or if critical market news are expected for the traded item(s).

Normally, all or parts of a bid quantity or quantity increment that are associated with a bid price that is furthest away from the reservation price would be accepted first. Thus bid quantities and/or quantity increments are first accepted from sellers with the lowest bid prices. Similarly, bid quantities and/or quantity increments are first accepted from buyers with the highest bid prices. Step 256 decides whether it is going to be a new bidding round. If so, the auction could then continue to receive new bids and/or clear the remaining number of active bids.

In a bidding round, the auctioneer may allow bids from all bidders or from a restricted number of bidders, such as the first bidder that submits a bid. Some of the bids may be intra-round bids, be submitted as flexible information to a proxy agent or be submitted from a proxy agent. Bidding rounds could be discrete with a specified time period of each round or bidding could occur continuously. Note that a static (single bidding round) auction, e.g. as in FIG. 28, could be considered as being a special type of dynamic auction, where the number of bidding rounds has been set to one. Thus, normally the embodiments that we discuss for dynamic auctions are also applicable to degenerate dynamic auctions with one bidding round, i.e. a static auction.

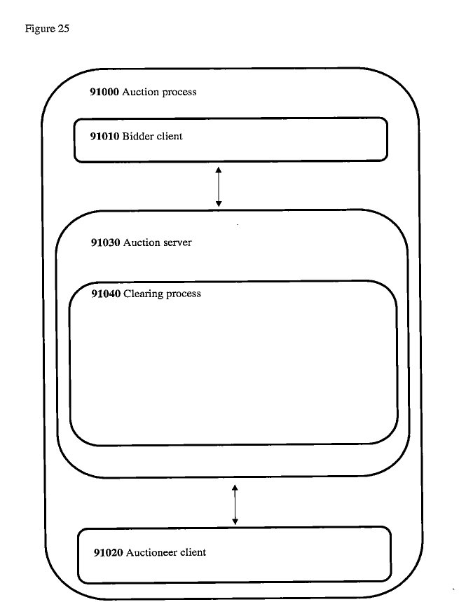

In an exemplary embodiment, which is illustrated by FIG. 25, the auction process 91000 can be divided into three types of subprocesses: a bidder client 91010, an auctioneer client 91020 and an auction server 91030. In FIG. 25 there is only one bidder client, but alternative embodiments could have several bidder clients, e.g. one bidder client per bidder. This would speed up the auction if the bidder clients would be parallel processes. In special embodiments an auction process could also have a plurality of auctioneer clients. In special cases, such as in some combinatorial auctions, there could also be multiple auction servers that manage market clearing for multiple items. There are alternative embodiments where the auctioneer client interacts directly with the bidder client. An auction process could receive bids and manage market clearing for a plurality of item types. However, if the bids and clearing processes are independent for different types of items, then we can separate bid management and the clearing processes into a separate auction process for each type of item. In principle the auction process could execute all tasks of the auctioneer.

### Package Transformations

In this subsection we will give examples of package definitions and package transformations. For some aspects of our invention, the package definition is used to get desirable properties of packages, such as that packages are approximately independent for one or more traders. Sometimes it will be necessary that a package contains a negative amount of an underlying item to get this property. Moreover, allowing the quantity of an underlying item in a package to be a long decimal number, such as 23.444566, will often make it easier to ensure that packages have desirable properties, as this would often mean that approximation errors can be reduced.

It is convenient, but not necessary, to use matrices and vectors when analyzing packages and transformations of packages. Matrix algebra is a convenient and compact way to analyse linear transformations of a set of elements. Our intention is that the terms matrix and matrix manipulation should be interpreted in a general sense. When we discuss a matrix manipulation in this specification, the discussion also applies to an equivalent linear transformation of a set of elements. Moreover, when we discuss a matrix property, the discussion also applies to the property of an equivalent linear transformation. The foundations of Matrix analysis is for example presented by Horn and Johnson (1985).

Most package definitions can be represented by a matrix, which we denote by A. In matrix notation, Aᵢⱼ is normally the element in row i and column j of matrix A. Alternative representations are possible, but in this specification we let element Aᵢⱼ of matrix A denote the quantity of item i that is contained in package j. This convention can be used to represent most package definitions, and many package transformations would correspond to manipulations of A.

If item 1 is an ellipse, item 2 a romb and item 3 a triangle, then the package definition in FIG. 55 can be represented by the following matrix:

$$A = [ \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ] = [ \begin{matrix}2 & 1 & 2 \\ 3 & 2 & 2 \\ 1 & 2 & 2\end{matrix} ] . \qquad ( 0 )$$

As another example, consider the case with two underlying items. One unit of the first package type consists of A₁₁ units of item 1 and A₂₁ units of item 2, while the second package type has A₁₂ units of the first item and A₂₂ units of item 2. The amount of underlying items q₁ and q₂ that are contained in \tilde{q}₁ units of the first package type and \tilde{q}₂ units of the second package type can be calculated as follows:

$$[ \begin{matrix}{q}_{1} \\ {q}_{2}\end{matrix} ] = [ \begin{matrix}{A}_{11} & {A}_{12} \\ {A}_{21} & {A}_{22}\end{matrix} ] [ \begin{matrix}{\tilde{q}}_{1} \\ {\tilde{q}}_{2}\end{matrix} ] = [ \begin{matrix}{A}_{11} {\tilde{q}}_{1} + {A}_{12} {\tilde{q}}_{2} \\ {A}_{21} {\tilde{q}}_{1} + {A}_{22} {\tilde{q}}_{2}\end{matrix} ] .$$

For cases with multiple package types and underlying items, we can use standard matrix and vector notation and write the corresponding relationship as follows:

q=A\tilde{q}, (1)

where \tilde{q} is a vector of quantities for each package type, and q is a vector of quantities for the underlying items. Similarly, item quantities can be transformed to package quantities as follows:

\tilde{q}=A⁻¹q. (1′)

Thus in order to make transformations in both directions, it is sometimes of interest to define packages such that both A and its inverse A⁻¹ exists. According to matrix algebra, this is true if A is a square matrix, unless its determinant is zero. The matrix corresponding to the package definitions in FIG. 55 corresponds to an invertible A, because the determinant of the matrix in (0) equals 4 and is therefore non-zero. A square matrix is invertible if its columns are linearly independent. A square matrix is also invertible if its rows are linearly independent. We say that a matrix is partly invertible if at least one of the following is true: rows are linearly independent: columns are linearly independent. In case the number of rows differ from the number of columns of a partly invertible matrix, then it is sometimes possible to get an invertible square matrix by either omitting one or more rows (i.e. omitting one or more item types) or by omitting one or more columns (i.e. omitting one or more package types) in A. The latter could for example be relevant for auctions that have more package types than there are underlying item types, as in FIG. 56. For example, it could be relevant for a bidder that only submits bids for three of the packages in FIG. 56 to remove the column in A that corresponds to the package type that it does not use.

DEFINITION: We say that a set of package types are partly linearly independent, if the set of package types can be represented by a matrix A that is partly invertible.

DEFINITION: We say that a set of package types are linearly independent, if the set of package types can be represented by a matrix A that is invertible.

Similarly, a (horizontal) vector of prices, p, for underlying items can be transformed into a corresponding (horizontal) vector of prices for package types, \tilde{p}.

\tilde{p}=A^{T}p (2)

where A^{T} is a transposed version of A, i.e. the columns of A^{T} are identical to the rows of A. Similarly,

p=(A^{T})⁻¹\tilde{p}. (2′)

Prices \tilde{p} correspond to p in the sense that the total transaction cost for \tilde{q} package types at price \tilde{p}=A^{T}p is the same as for q=A\tilde{q} units of the underlying items at prices p:

p^{T}q=p^{T}A\tilde{q}=(A^{T}p)^{T}\tilde{q}=\tilde{p}^{T}\tilde{q}.

We say that a package transformation with this property is invariant with respect to transaction costs.

Definition: We say that a package transformation is approximately invariant with respect to transaction costs if p^{T}q and \tilde{p}^{T}\tilde{q} differ by at most 1% of the absolute value of p^{T}q.

The expressions above can also be used to transform quantities for one type of package into quantities for another type of package. Let Ă be another package definition, so that:

q=Ăq̆

and

p=(Ă^{T})⁻¹p̆.

where q̆ is a vector with the number of units for each new package type and p̆ is a vector of prices for the new package types. Thus it follows from expressions in (1) and (1′) that:

\tilde{q}=A⁻¹q=A⁻¹Ăq̆(Ă⁻¹A)⁻¹q̆

and from (2) and (2′) that:

\tilde{p}=A^{T}p=A^{T}(Ă^{T})⁻¹p̆=(Ă⁻¹A)^{T}p̆.

Thus the matrix Ă⁻¹A can be used to transform between prices and quantities for different package definitions that have similar underlying items.

DEFINITION: A price-quantity data transformation from a package definition A to a package definition B, transforms a set of prices and quantities for package definition A to a corresponding set of prices and quantities for package definition B, where both package definitions have the same underlying items.

One purpose with making new definitions of packages is that new package types could be approximately independent for relevant traders at relevant prices. We refer to this as independence transformations and this can be achieved by diagonalizing the Jacobian matrix, a matrix with partial derivatives, of a multivariate transaction schedule. The advantage with such a transformation is that the trader can (approximately) separate its bid decisions for approximately independent package types.

The Jacobian (slope) of the marginal cost function (the Hessian of the cost function) indicates how the marginal cost of a seller changes when it changes its production. We denote this Jacobian by C, where a row of the matrix corresponds to changes in the marginal cost for an item type with respect to changes in the output of each item type. The matrix is a local representation of how the marginal cost changes with the output level. This slope of the marginal cost function can be transformed into a corresponding slope C of the marginal cost function with respect to package types.

\tilde{C}=A^{T}CA, (3)

where A corresponds to the definition of packages. In theory, the Hessian of the cost function is symmetric. In this case, it is known from the literature on diagonalization of symmetric matrices, which we discussed earlier in this specification, how to find a matrix A, such that \tilde{C} is a diagonal matrix. Imperfections can occur in practice, but as long as C is approximately symmetric, it would normally be possible to find a matrix A, such that \tilde{C} is approximately diagonal, which is an example of an independence transformation for the considered seller.

A seller's supply curve would correspond to a statement of its cost function. It might differ from the true cost function of the seller, because for strategic reasons a seller may find it profitable to state its costs differently from its true cost. The Jacobian of a submitted supply curve of a strategic seller is a matrix where the elements are (or at least related to) own-price (diagonals of matrix) and cross-price sensitivities for considered package types. Normally this matrix corresponds to the inverse of the Hessian of a stated cost function. The inverse of a diagonal matrix is diagonal, so if the Hessian of the stated cost function is diagonal then the Jacobian of the supply function should also be diagonal, which would normally mean that cross-price sensitivies are equal zero. Moreover, the Hessian of the true cost function would normally be diagonal or close to diagonal if the Hessian of the stated cost function is diagonal.

We denote the Jacobian (slope) of a buyer's marginal valuation by the matrix D. This is often a matrix where the elements are own-price and cross-price sensitivities for considered package types. A row of this matrix gives changes in the marginal valuation for an item type with respect to changes in the procured quantity of each item type. This slope can be transformed into a corresponding slope \tilde{D} for the marginal valuation for package types.

\tilde{D}=A⁻¹D(A⁻¹)^{T}, (4)

where A⁻¹ is the inverse of the matrix A. In theory, D is a symmetric matrix. In such cases, it is known from the literature on diagonalization of symmetric matrices, how to find a matrix A, such that \tilde{D} is a diagonal matrix. This is an example of an independence transformation for the considered buyer. Note that for a strategic buyer, the demand curve may not be an exact representation of the buyer's valuation. Still, if the cross-price sensitivity of a trader's demand curve is negligible for some package definition, then the trader's marginal valuation of package types should be approximately independent.

In multi-unit auctions, transaction curves are often constrained to be univariate. In such cases, standard microeconometric methods can be used to estimate multivariate transaction curves or the underlying cost functions of sellers and valuations/preferences of buyers.

It is often assumed that cost functions of sellers are convex and that demand functions are concave. In this case, as is known from literature on simultaneous diagonalization of symmetric matrices, a package definition A can be chosen such that both \tilde{C} and \tilde{D} become diagonal. Alternatively, the demand functions of two buyers or the supply functions of two sellers can be simultaneously diagonalized. Unless circumstances are benevolent, it is generally not possible to simultaneously diagonalize several matrices. However, as mentioned earlier in the specification, several matrices can often be simultaneously/jointly approximately diagonalized, even if matrices are not necessarily symmetric. Moreover, an auction may trade more package types than underlying item types. With sufficiently many package types, this means that each bidder could bid on a subset of package types that are (approximately) independent for that bidder. Jacobians of supply functions may change with the price and Hessians of cost functions may change with output for a single bidder. In this case, joint approximate diagonalization and many package types can be used to make traded package types, or a subset of them, approximately independent for a bidder in a wider price region or quantity region.

Definition: An independence transformation of packages starts with the underlying items, or some package definition of the underlying items, and then uses a mathematical transformation, including methods that diagonalize a matrix or approximately jointly diagonalize a plurality of matrices, and ends up with a new set of package types, where at least two of them are approximately independent at some vector of prices for at least one trader.

With an inverse independence transformation, we mean a mathematical transformation that reverses the independence transformation, so that if one makes an inverse transformation followed by an inverse independence transformation, then one should, within a small margin of numerical errors, be back to the package definition that one started with.

One can also transform slopes of the marginal costs and marginal valuations in the reverse direction:

C=(A⁻¹)^{T}\tilde{C}A⁻¹ (5)

This would be an example of an inverse independence transformation if C is diagonal. Similarly,

D=A\tilde{D}A^{T}. (6)

Symmetry, convexity and concavity properties of transaction schedules are invariant with respect to the transformations in (3) and (4). For example, if C is symmetric and positive definite, then the diagonalized version, \tilde{C}, also has these properties. Thus symmetry, convexity or concavity of a transaction schedule are suitable properties for bidding formats and activity rules, as they do not depend on how packages are defined. Thus those properties can remain unchanged even if packages are redefined.

We say that package definitions are non-linear if package definitions depend on volumes or prices. Still, the matrix A could be a constant in a sufficiently small region of prices and/or quantities, which could be of an infinitesimally small size. Within such a region, the transformations in (3)-(6) could still be valid. Moreover, it would often be possible to transform quantity increments Δ\tilde{q} for packages and price changes for packages Δ\tilde{p} into corresponding changes for underlying items, and vice versa. For example,

Δq=AΔ\tilde{q}, (7)

Δ\tilde{q}=A⁻¹Δq, (8)

Δp=A^{T}Δp, (9)

and

Δp=(A⁻¹)^{T}Δ\tilde{p}. (10)

It can be shown that:

Δp^{T}Δq=Δp^{T}AΔ\tilde{q}=(A^{T}Δp)^{T}Δ\tilde{q}=Δ\tilde{p}^{T}Δ\tilde{q}.

DEFINITION: We say that a package transformation is locally approximately invariant with respect to transaction costs if Δp^{T}Δq and Δp^{T}Δq differ by at most 1% of the absolute value of Δp^{T}Δq. In addition, a package transformation that is approximately invariant with respect to transaction costs is also locally approximately invariant with respect to transaction costs.

Local transformations of quantity increments can for example be useful as part of a rationing process, where a bundle rule A is chosen such that relevant packages are approximately independent for a bidder around the marginal prices. Note that in a rationing process independence is normally only relevant for bidders that are to be rationed and for items/packages that are to be rationed.

For non-linear packages, where A depends on prices and/or quantities, it is sometimes possible to use (7)-(10) to transform prices and quantities increment by increment. Such a non-linear transformation can also be useful when transforming a list of market orders and/or a list of price-quantity pairs.

### Embodiment for Bidder Client

Some auctions would have one bidder client and some auctions would only have one bidder. But an automatic process could also have a plurality of (two or more) bidder clients that can interact with a plurality of bidders at almost the same time, i.e. bidder clients could be parallel processes. A bidder client could communicate with one auction server that manages the trade of units for one or more types of items. In some cases, such as when trading of different types of items are managed by different auction servers, a bidder client could communicate with a plurality of auction servers. A bidder client could act as a proxy bidding agent. In this case, the bidder submits flexible bid information to the bidder client, which then uses this information to submit bids to the auction server on behalf of the bidder. The bidder client can then bid on behalf of the bidder without much further communication with the bidder.

The flow chart in FIG. 34 illustrates how a bidder client communicates with both an auction server and one or more bidders. In the first step 900, which can be omitted in some embodiments, a bidder registers for the auction. The bidder client communicates this information to the auction server. In the second step 901, the bidder client receives information from the auction server about the auction design, including bidding format and definition of packages, which would have some aspects of our invention. The information is presented to the bidder. In an alternative embodiment, the bidder client may receive and present information about the auction format before registering for the auction. Step 901 could also be omitted, for example in case a bidder can easily find this information by other means. In the third step 902, the bidder inputs bids to the bidder client, or are given an opportunity to input bids. A bid might be flexible bid information, so that the bidder client can bid repetitively on behalf of the bidder. In the fourth step 903, the bidder client verifies that bids comply with a bidding format, which might have aspects of our invention, and then the bidder client forwards the bid(s) to the auction server. In the fifth step 904, the bidder client receives information from the auction server about the auction outcome. The information is presented to the bidder. This step may also have aspects of our invention.

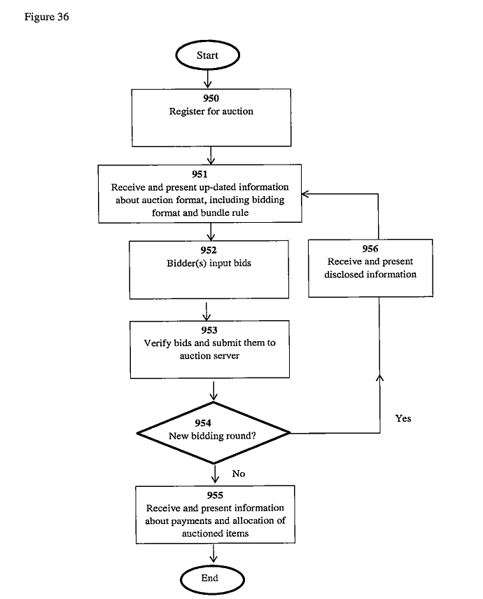

FIG. 36 describes the flow chart when the bidder takes part in a dynamic auction with additional steps. After bids have been verified and communicated to the auction server in step 953, there is one additional step 954, where the bidder client may receive information from the auction server on whether there is going to be a new bidding round. Note that the bidder client may not receive such information, for example if the number of bidding rounds is predetermined and announced to the bidder at the beginning of the auction. Another additional step 956 is that if there is a new bidding round, then the bidder client may receive new auction relevant information, such as characteristics of bids (including competitors' bids) in previous rounds. The new auction relevant information or part of it is presented to the bidder. Before the bidder is allowed to submit additional bids in the new bidding round, there is a step 951, where the bidder client may receive updated information about the auction design, including possible changes in the bidding format and bundle rule. This information could for example come from the auction server or auctioneer client. Note that bundle rule and definition of packages have essentially the same meaning in our specification. The updated information or parts of it is presented to the bidder.

In an alternative embodiment, the auction may determine the allocation for some items (called clinching in clock auctions), while continuing receiving new bids for the remaining items. Such an example is illustrated for a bidder client by the flow chart in FIG. 35. A similar flow chart could also be used to represent the bidding process of an exchange with continuous trading. In this embodiment, the step 974, where disclosed information is received would normally also include a complete or partial disclosure of the auction's allocation decisions. Bidders would normally also receive an update of their active bids.

### Auctioneer Client

The auctioneer client is an automatic process. It would normally communicate with the auctioneer and auction server, but sometimes also with bidder clients. The same auctioneer client may communicate with a plurality of auction servers. In some cases, the same auctioneer client might communicate with multiple auctioneers.

In an exemplary embodiment of our invention, the auction process runs the auction automatically, so that there is no need of a human auction operator. In this case, the auction could sometimes operate without an auctioneer client, or the auctioneer client could operate without any interaction with a human operator. In an alternative embodiment, a human operator interacting with the auctioneer client may take a passive or an active part in the operation of the auction. It might be that the auction process' recommendation on whether to start a new bidding round or that the auction process' allocation recommendation needs the approval of a human operator via the auctioneer client. Similarly, it might be that a human operator needs to approve an automatic up-date of the auction format before it goes into effect. It could also be the case that the human operator has the possibility to overrule recommendations from the auction process. The human auction operator may make decisions in exceptional circumstances, and use the auctioneer client to communicate with bidders or help bidders with placing bids when they have problems to communicate with the auction server.

The auction process could disclose information automatically to bidders, including information about the determined allocation, or after approval or assistance by a human operator via the auctioneer client.

### Auction Server

In many embodiments, the main task of the auction server is to receive bid data from one or more bidder clients in one or more bidding rounds, to clear those bids in a clearing process, and to report the result of the clearing process to the bidder client(s). To the bidder clients, it may also send information about the auction format, progress of the auction and other information that should be presented to bidders. Often the auction server would also keep the auctioneer client up-dated of the progress of the auction, and the auction server may receive information, for example about auction format and bidding rounds, from the auctioneer client. In an exemplary embodiment, the clearing process 91040 is a subprocess of the auction server 91030. This is illustrated by FIG. 25.

Alternative Embodiment with Package Definitions that are Updated

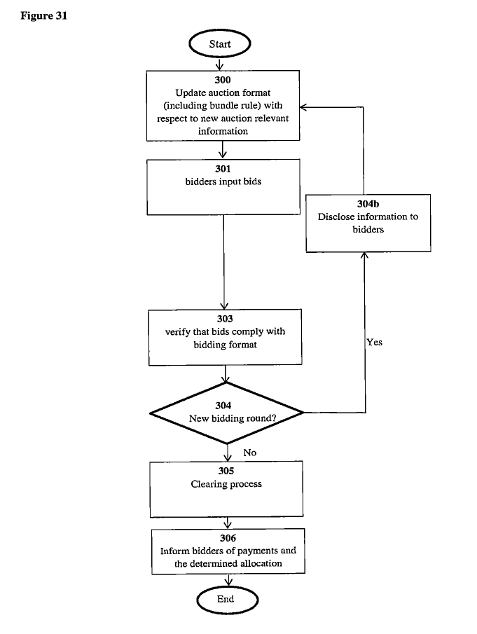

Any information that will influence the predicted outcome of the auction (including clearing prices, bids and allocations) is auction relevant information. Auction relevant information normally includes market news, how many bidders registered for the auction, what are the characteristics of registered bidders, how did registered bidders bid in previous auctions, what was the outcome of previous auctions. This type of information can be used to estimate properties of sellers' costs and buyers' valuations, and therefore also how packages should be defined. In a dynamic auction, bids in previous rounds could also be used to update the bidding format and bundle rule for a next round. FIG. 31 presents a flow chart of an embodiment of our invention with this updating feature. Note that the auction format includes the bidding format and bundle rule. A difference between FIG. 31 and the flow chart in FIG. 29 is that we have changed the first step of each bidding round, so that the auction format is now updated with respect to new information that has arrived before a new bidding round starts.

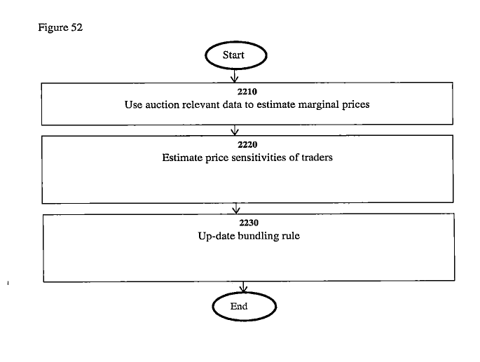

FIG. 52 presents a possible embodiment of the up-dating process in more detail. A first step 2210 could be to use auction relevant information to predict the marginal prices for traded packages/goods. For example, forward market prices would directly give such an estimate, if there exists forward prices for the traded goods/packages. The next step 2220 could use methods, such as microeconometrics, to estimate price sensitivities, such as own and cross-price sensitivities, of traders (bidders and perhaps also the auctioneer) at those prices. The estimated price sensitivities could either be the underlying true price sensitivities or price sensitivities that correspond to transaction curves that bidders would choose strategically in an auction. Based on these price sensitivities at the estimated marginal prices, the auction computer can choose a new bundling rule to improve auction performance. The new bundling rule could for example make packages approximately independent for relevant traders at the estimated marginal prices. Another alternative would be to make packages closer substitutes. If appropriate, the up-dating of the bundling rule may also include a transformation of transaction curves that were submitted for an old bundling rule.

Embodiments as in, or similar to, FIG. 52 could also be used when establishing the auction format at the start of an auction, as in step 100 in FIG. 28 and step 250 in FIG. 29.

DEFINITION: We say that the bundle rule of the auction design is updated automatically if there is some auction relevant information that could arrive to the auction process that will change the bundle rule automatically without any interference from a human operator, except that a human operator may have to acknowledge updated properties of the auction design. A human operator may also have the possibility to correct an up-dated auction design. The updating aspect of our invention does not require that the bundle rule is updated for each bidding round, it is enough that there are some circumstances when the arrival of new information leads to an update of the bundle rule in or before at least one of the bidding rounds.

A more narrow definition of auction relevant definition that we use in this specification is external auction relevant information.

DEFINITION: External auction relevant information is auction relevant information that does not originate from the auction process, the auctioneer, or bidders' interaction with the auction process or auctioneer, but which could still be used to predict the auction outcome.

Examples of external auction relevant information could be forward prices, when issued prices, prices of related items that are traded in other auctions and markets or by another auction process, any external information that can be used to predict clearing prices, the supply side of the auction, any external information that can be used to predict the demand side of the auction, economic macro data etc. Other examples of external auction relevant information that is primarily relevant for stock exchanges are: stock splits, stock mergers and profit warnings. However, note that forward prices of an item or when issued prices of an item would not be external auction relevant information for an auction process that trades those particular contracts for that particular item. Information from bidding or clearing for related items that are cleared independently of an item could be regarded as external auction relevant information for that item, even if the items are traded by the same auctioneer and/or by the same machine or computer.

We also introduce the following concept:

DEFINITION: We use non-bid characteristics of bidders to describe auction relevant characteristics of bidders, including how many bidders have registered for the auction and how many bidders are active in the auction, but excluding bid data and auction outcomes from present or previous bidding rounds of the same auction process.

When up-dating the bundle rule, one could potentially make exceptions for active bids that were submitted for an old bundle rule, and allow them to be active for the old bundle rule. Alternatively, such orders could be cancelled or transformed to the new updated bundle rule.

Sometimes, an auctioneer may be able to predict how bidding behaviour will change during a period. A wholesale electricity market is one such example, where demand and the price vary fairly predictably during the day. In such cases up-dating of the auction format can be predetermined before a dynamic auction or a sequence of auctions starts.

Embodiments with Automatic Dispatch

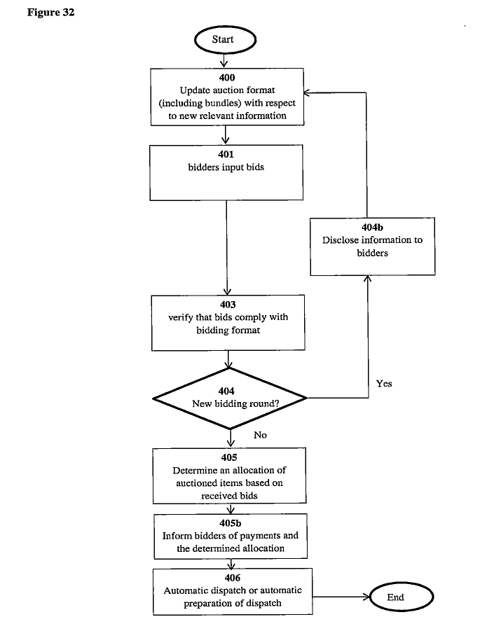

As illustrated by step 406 in FIG. 32, the determined allocation could be automatically dispatched or prepared for dispatch or delivery by the auction process, perhaps in cooperation with one or more automatic processes, dispatch clients. Similar automatic dispatch steps could be added in our other flow charts of an auction process at a point where the auction process has calculated an allocation for submitted bids. Examples of automatic dispatches in real-time are: automatic dispatch orders sent at the end of an auction to electricity consumers, electricity generators or network operators of an electric power network; automatic dispatch orders sent to network operators and clients in telecommunication systems; automatic dispatch orders sent to vehicles, such as airplanes, cars, trucks, trains, boats, taxis etc., in a traffic network; automatic orders to prepare auctioned items for delivery and/or to deliver such items. Delivery and preparation for delivery could for example involve automatic collection of items from a storehouse, automatic packaging of items, automatic mail processing, including automatic printing of delivery addresses for packages and letters.

### Computer Implementation

The auction process can be implemented on an auction computer system. In an exemplary embodiment of the auction computer system, each bidder interacts with a bidder computer and the auctioneer interacts with an auctioneer computer. The clearing process, a subprocess of the auction process, is implemented on an auction computer. In alternative implementations some bidders may share the same bidder computer. The same bidder may also have access to several bidder computers. An auctioneer may also have access to several auctioneer computers or interact directly with the auction computer. The auctioneer computer is optional. Some embodiments of the auction computer system do not have an auctioneer computer. Under special circumstances a bidder may interact with the auctioneer computer or directly with the auction computer. The auction computer system may also have an optional support computer, where parts of the auction process could be implemented. Parts of the auction process could also be implemented on the bidder computer(s) and the optional auctioneer computer. For example, there could be advantages with implementing a bidder client (process) on a bidder computer. An optional auctioneer client (process) could be implemented on the optional auctioneer computer. In exemplary embodiments, most parts of the auction server (process), in addition to the clearing process, would be implemented on the auction computer. In some embodiments the whole auction process could be implemented on the auction computer.

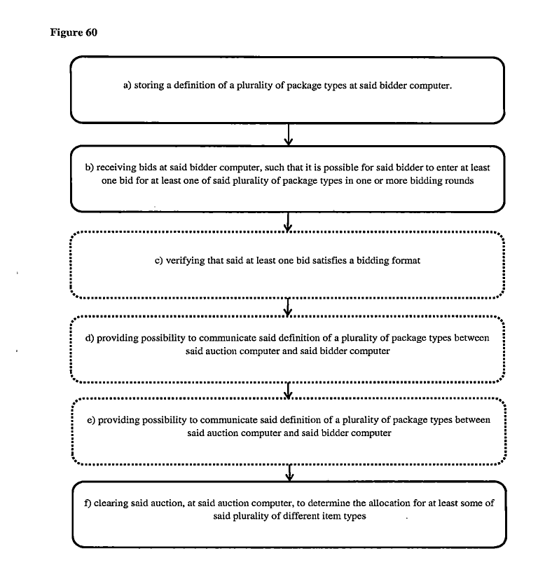

In an embodiment, a method for enabling a bidder to participate in an auction that trades a plurality of different item types is provided and illustrated in FIG. 60. Often said plurality of different item types would be of significant value in said auction. Normally a set of items that are to be traded in said auction would altogether be worth a value equivalent to at least $1,000. The method is implemented in a multiprocessor computer system and comprises:

i) an auction computer;

ii) a bidder computer;

iii) a computer network connecting said auction computer and bidder computer; said method comprising

a) storing a definition of a plurality of package types at said bidder computer and/or said auction computer, which in one example would be presented on the interface of said bidder computer. In an exemplary embodiment, said package types would be defined in order to facilitate separate trading of package types, which would also facilitate, and often speed-up, trading of said plurality of different item types. Ideally package types would be approximately independent for said bidder, which for example is the case if cross-price sensitivities of said bidder would be approximately zero for considered package types. As explained in the specification, such package types can, for example, be found by applying independence transformations, which, for example, would apply a technique that jointly diagonalizes a plurality of matrices. Normally said plurality of matrices would include a matrix where the elements of said matrix are own-price and cross-price sensitivities of said bidder for considered package types. In alternative embodiments, it would instead be interesting to define package types that are close substitutes. This could, for example, facilitate trading in a product-mix auction. For these purposes, the plurality of package types would in some exemplary embodiments be defined such that i) said plurality of package types are different from each other; ii) said plurality of package types are partly linearly independent; iii) each of said plurality of different item types is contained in at least one of said plurality of package types; iv) at least one of said plurality of different item types is contained in at least two of said plurality of package types; v) each of said plurality of package types contains at least one of said plurality of different item types, and no other item type than item types included in the plurality of different item types; vi) there is at least one out of said plurality of package types that contains at least two of said plurality of different item types. The method may further comprise b) receiving bids at said bidder computer, such that it is possible for said bidder to enter at least one bid for at least one of said plurality of package types in one or more bidding rounds. For exemplary embodiments, the management of several bidders would be processed in parallel on a multiprocessor system.

Optionally, the method includes c) verifying that said at least one bid satisfies a bidding format. For example, the bid price of said at least one bid should in exemplary embodiments often be in a discrete set of permissible prices. Bid prices could be chosen implicitly or explicitly by said bidder. Often bids from said bidder would have to follow an activity/monotonicity rule.

The method may further optionally comprise d) providing possibility to communicate said at least one bid for at least one of said plurality of package types to said auction computer via said computer network, wherein error control is applied in said providing possibility to communicate said at least one bid. Exemplary embodiments would use Automatic Repeat reQuest (ARQ) as part of the error control. Communication of said at least one bid could be partly encrypted. In many practical applications, a local area network and internet would be part of said computer network.

The method may further optionally comprise e) providing possibility to communicate said definition of a plurality of package types between said auction computer and said bidder computer. This communication could take place before or after said bidder has entered at least one bid in step b). The latter would often be the case if said bidder has defined said plurality of package types. In this case the package definition would normally be sent from said bidder computer to said auction computer. If package types have instead been defined by the auction process, then said definition of a plurality of package types would often be sent from said auction computer to said bidder computer before said bidder has entered at least one bid in step b).

The method may further comprises f) clearing said auction, at said auction computer, to determine the allocation for at least some of said plurality of different item types. Said clearing said auction could for example be such that a marginal price is calculated for each of said plurality of package types, and that said plurality of different item types are allocated as contents of said plurality of package types. Another option would be that said clearing said auction is such that a marginal price is calculated for each of said plurality of different item types, and that said plurality of different item types are allocated without packages. A third option would be to submit bids for said plurality of package types, then to clear the auction for another set of package types, and to allocate said plurality of different item types as contents of those said another set of package types.

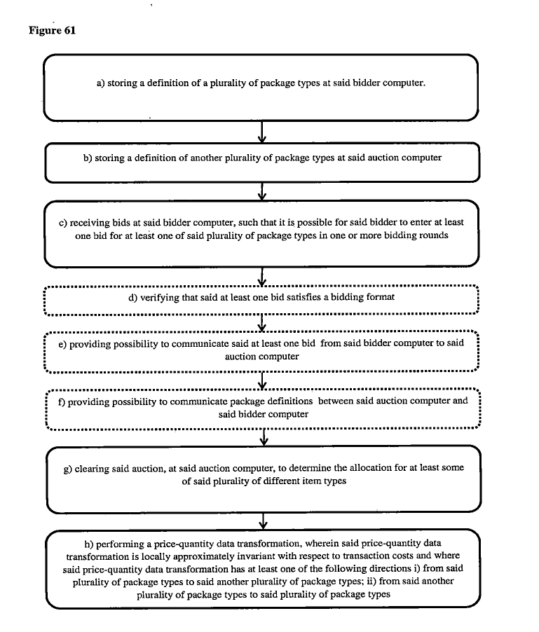

In FIG. 61, we illustrate another method for enabling a bidder to participate in an auction that trades a plurality of different item types. This method uses different definitions of package types in said auction. This could for example be the case if each bidder has its own package types. Individual package types would ideally be such that each bidder can make separate bidding decisions for each package type, and/or such that it is easier to present relevant information to each bidder. It could also be that the auctioneer wants to have individual package types when it is inputting data or receiving information from said auction. Individual package types would normally be transformed to/from common package types that are used in the clearing process. In an exemplary embodiment, the method may be implemented in a multiprocessor computer system comprising i) an auction computer; ii) a bidder computer; iii) a computer network connecting said auction computer and bidder computer; said method comprises:

a) Storing a definition of a plurality of package types at said bidder computer and/or said auction computer, such that:

i) said plurality of package types are different from each other,

ii) each of said plurality of different item types is contained in at least one of said plurality of package types;

iii) each of said plurality of package types contains at least one of said plurality of different item types, and no other item type;

b) Storing definition of another plurality of package types at said auction computer. The definition of the another plurality of package types may be defined such that: iv) said another plurality of package types are different from each other;

v) each of said plurality of different item types is contained in at least one of said another plurality of package types;

vi) each of said another plurality of package types contains at least one of said plurality of different item types. In other words, no other item type than the ones included in the plurality of item types are contained in the defined packet types;

vii) at least one of said another plurality of package types is different from all of said plurality of package types;

c) receiving bids at said bidder computer, such that it is possible for said bidder to enter at least one bid for at least one of said plurality of package types in one or more bidding rounds;

d) verifying that said at least one bid satisfies a bidding format;

e) providing possibility to communicate said at least one bid for each of said plurality of package types to said auction computer via said computer network, wherein error control is applied in said providing possibility to communicate said at least one bid;

f) providing possibility to communicate package definitions between said auction computer and said bidder computer, where said package definitions include at least one of the following: said definition of a plurality of package types; said definition of another plurality of package types;

g) clearing said auction to determine the allocation for at least some of said plurality of different item types.

h) performing a price-quantity data transformation, wherein said price-quantity data transformation is locally approximately invariant with respect to transaction costs and where said price-quantity data transformation has at least one of the following directions i) from said plurality of package types to said another plurality of package types; ii) from said another plurality of package types to said plurality of package types;

In one embodiment, the definition of said plurality of package types has been chosen by said bidder. In other words, the definition of the plurality of package types is defined by the bidder.

In one embodiment, at least one of the following is valid i) at least one out of said plurality of package types contains at least two of said plurality of different item types; ii) at least one out of said another plurality of package types contains at least two of said plurality of different item types.

In one embodiment, both of the following are valid i) at least one out of said plurality of package types contains at least two of said plurality of different item types; ii) at least one out of said another plurality of package types contains at least two of said plurality of different item types.

In one embodiment, the method further includes performing another price-quantity data transformation, such that the auction process comprises price-quantity data transformations in both directions i) from said plurality of package types to said another plurality of package types, ii) from said another plurality of package types to said plurality of package types.

In one embodiment, the one or more bidding rounds is one single bidding round.

In one embodiment, bids are received at said bidder computer, such that it is possible for said bidder to enter at least one bid for at least one of said plurality of different packages, such that said bidder has the possibility to choose one or more bid prices implicitly.

One aspect of our invention is that the auction can be partly or fully conducted separately for each package type. For example if package types have been chosen such that bidders can (approximately) make separate decisions for each package type. This also means that it becomes easier to execute subprocesses of the auction process in parallel. Ideally parts of the auction process could be executed in parallel for different package types. In one embodiment, a machine is provided that is a useful component when running an auction that trades a plurality of different item types, comprising:

i) a network interface that receives bid data;

ii) a non-transitory machine-readable medium storing;

a) a package definition comprising package type A and package type B, such that i) package type A and package type B are different; ii) package type A contains at least one of said plurality of different item types; iii) package type B contains at least two of said plurality of different item types; iv) package B contains a quantity that is a three-non-zero-digit number of at least one of said plurality of different item types.

b) said bid data, wherein parts of said bid data are associated with package type A and parts of said bid data are associated with package type B;

c) a sequence of instructions A, where the sequence of instructions A is relevant for package type A and said parts of said bid data are associated with package type A, wherein the sequence of instructions A do not have any reference to package type B and wherein the sequence of instructions A do not have any reference to said parts of said bid data are associated with package type B; d) a sequence of instructions B, where the sequence of instructions B is relevant for package type B and said parts of said bid data are associated with package type B and where the sequence of instructions B do not have any reference to package type A and wherein the sequence of instructions B do not have any reference to said parts of said bid data are associated with package type A;

iii) a multiprocessor system comprising two processor units, such that:

a) one of said two processor units can execute the sequence of instructions A while the other of said two processor units simultaneously execute the sequence of instructions B;

iv) a bus to transfer information between said network interface, said non-transitory machine-readable medium and said multiprocessor system;

In one embodiment, package B is defined to have a positive quantity of at least one of said plurality of different item types and a negative quantity of another of said plurality of different item types.

In one embodiment, packages in said package definition comprises package type A and package type B are partly linearly independent.

In one embodiment, the machine, where said package definition comprising package type A and package type B is up-dated automatically.

In one embodiment, a non-transitory machine readable medium is provided storing one or more sequences of instructions which, when executed in a multiprocessor computer system implements an auction process or method according to any of the methods disclosed herein, that enables a bidder to participate in an auction that trades a plurality of different item types.

In one embodiment, a non-transitory machine readable medium stores one or more sequences of instructions which, when executed in a multiprocessor computer system implements an auction process or method, for example one of the embodiments that have been discussed above, that enables a bidder to participate in an auction that trades a plurality of different item types.

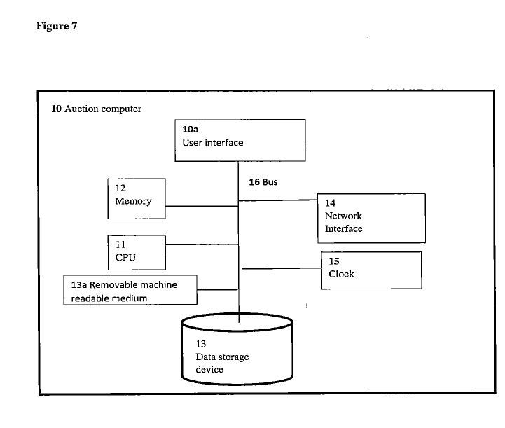

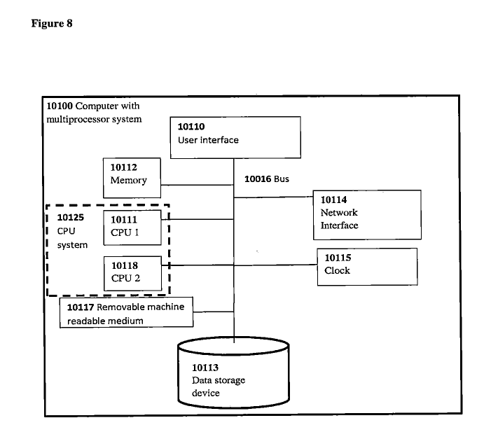

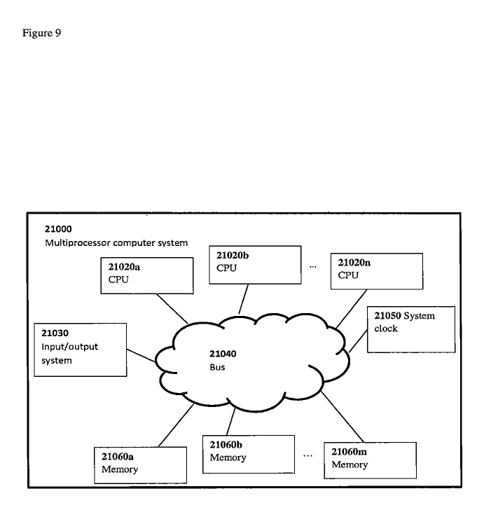

The auction computer, the bidder computer(s), the optional auctioneer computer, and the optional support computer can communicate through a network. FIG. 6 presents an exemplary embodiment of an auction computer system where an auction computer 10 and one or more bidder computers (20a-20n) and the auctioneer computer 30—are located in different nodes of the network 40. As shown in FIG. 6, the auction computer, bidder computers and the auctioneer computer are connected to the network 40 via network interfaces 14, 24a-24n and 34, respectively. Thus the auction computer, bidder computers and auctioneer computer can communicate through the network 40. In other embodiments, one or more bidder computers could be in the same node. In some special cases, one or more bidder computers may be in the same node as the auction computer. In an alternative embodiment, the auctioneer uses the user-interface 10a in FIG. 7, which is connected directly to the auction computer 10, to communicate with the auction computer. Such an alternative embodiment may not have a separate auctioneer computer. In an alternative embodiment, the auction computer could be a system of computers that is spread across different nodes. Similarly, a bidder computer could be a system of computers that is spread across a plurality of nodes. This could be advantageous if there is a team working for the same bidder and/or if a bidder is a corporation with several employees that are authorized to submit bids in the name of the corporation. In such cases, it could also be advantageous to let a plurality of bidder clients manage the same bidder. Similarly, an auctioneer may have several employees or representatives that help with the operation of the auction from different computers. Thus an auctioneer computer could be a system of computers, which could be spread across different nodes of the network.

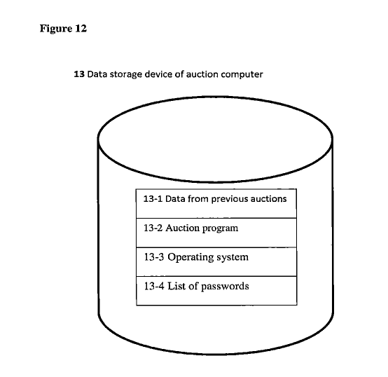

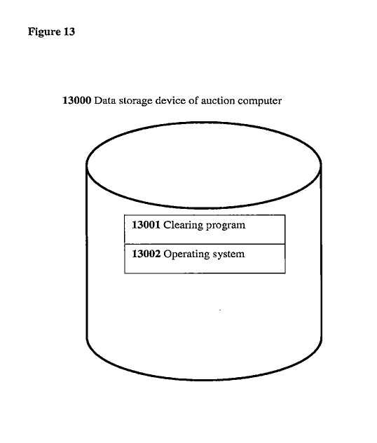

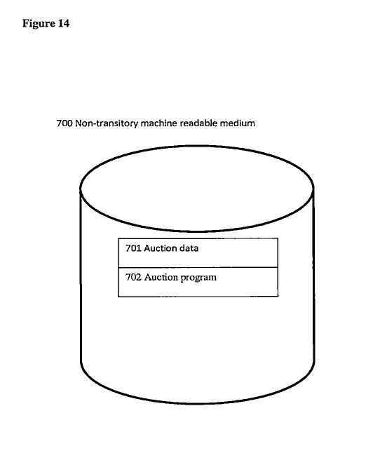

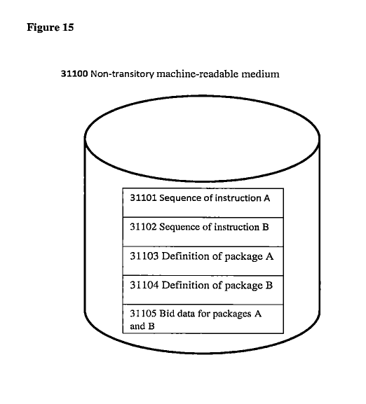

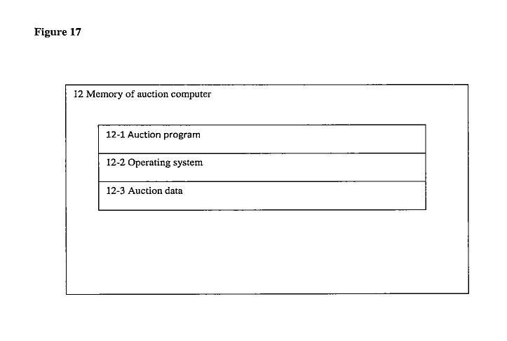

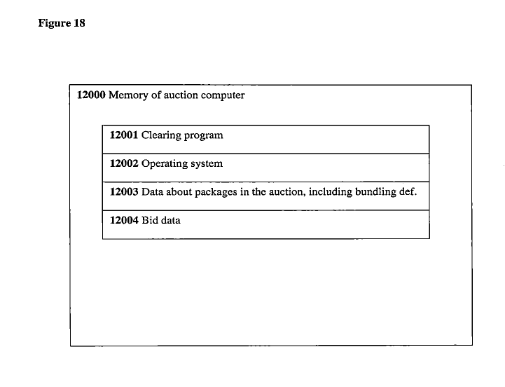

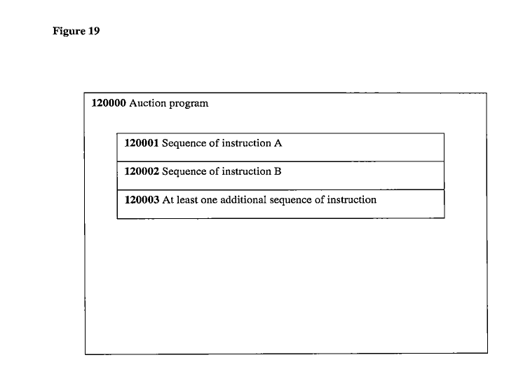

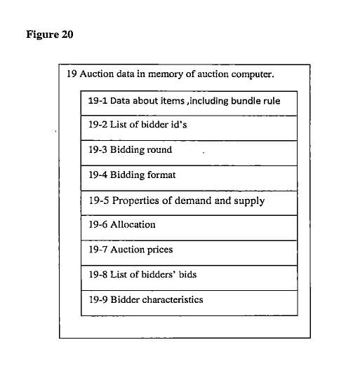

FIG. 7 shows an embodiment of an auction computer 10. In this particular embodiment the auction computer is a single computer comprising the following computer components: one central processing unit (CPU) 11, one system clock 15, one (non-transitory) memory 12, one network interface 14, one (non-transitory) data storage device 13, and one bus 16 that transfers data between components inside the auction computer. In addition, the auction computer may also have an optional user interface 10a and the auction computer may be connected to an optional non-transitory, removable machine readable medium 13a. As shown in FIG. 12, the exemplified data storage device 13 can, among other things, store data from previous auctions 13-1, an operating system 13-3, a list of bidders' passwords 13-4, and an auction program 13-2. As shown in FIG. 14, the auction program 702 and all or part of the auction data 701 can also be stored on a non-transitory, machine readable medium 700. The machine readable medium could for example correspond to Memory 12 in FIG. 7, or the medium could be removable and may correspond to the Removable machine readable medium 13a in FIG. 7. The CPU 11 of the auction computer 10, as exemplified in FIG. 7, is normally ready to run a clearing process (perhaps also auction server process or auction process) when the operating system (13-3 in FIG. 12), the auction program (13-2 in FIG. 12) and auction data (19 in FIG. 20)—such as bidder id's 19-2, bidding format 19-4, Properties of demand and supply 19-5, bidder characteristics 19-9 (such as historic bids, financial constraints, transaction constraints, VIP status and measured size of bidder), and data about items (including bundles) in the auction 19-1—are fully or partly uploaded in the memory (12 in FIG. 7). An alternative example of a memory with related contents is shown in FIG. 17. FIG. 18 presents another example with alternative contents of an auction computer that include a clearing program 12001 that when executed starts a clearing process. As illustrated by FIG. 19, a program can include several sequences of instructions, which potentially could be executed in parallel. FIG. 15 illustrates a non-transitory machine readable medium that stores such sequences. In an exchange, the list of bidder's bids 19-8 in FIG. 20 could correspond to the order book with open bids.

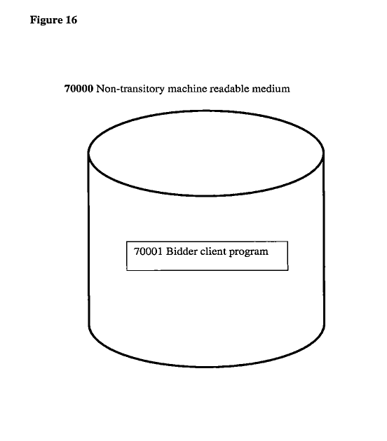

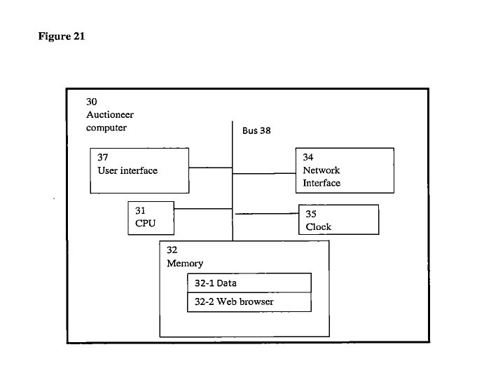

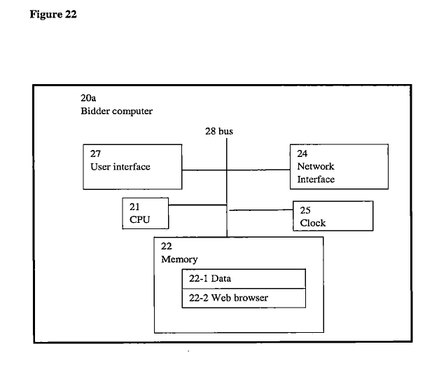

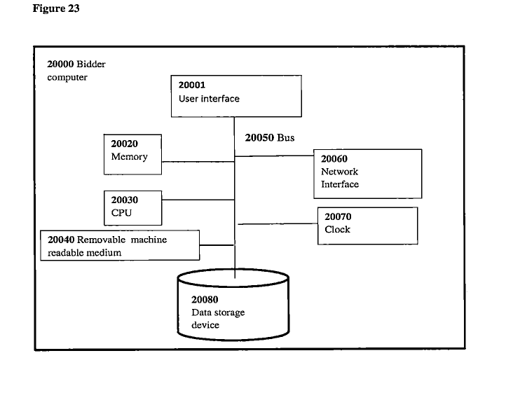

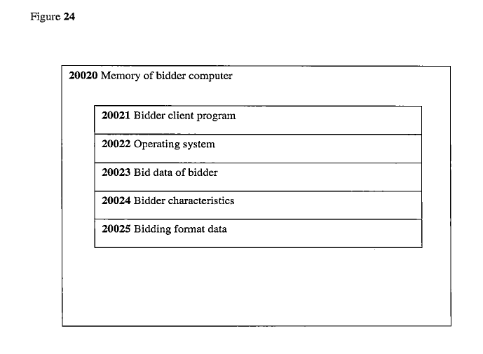

Computers could be of many different types. In FIG. 21 and FIG. 22, the auctioneer computer and bidder computer are thin clients; they have data and a web browser (for example, Internet Explorer or Netscape) in the (non-transitory) memory (such as 32 in FIGS. 21 and 22 in FIG. 22). With such an embodiment all or most of the auction process would be implemented on the auction computer and/or support computer. FIG. 23 presents an embodiment of a more advanced bidder computer with more computer components. In an exemplary embodiment the bidder computer is used by one bidder. FIG. 24 presents the memory 20020 of the more advanced bidder computer for an embodiment where a bidder client has been implemented on the bidder computer. The memory for example stores bid data of that bidder 20023 and bidder characteristics 20024 of that bidder. In some embodiments bid data would include flexible bid information. Bidder characteristics could for example include the following: VIP or membership status of the bidder, password of the bidder, financial constraints of the bidder and a measure of the size of the bidder. In the considered embodiment, the memory 20020 has also stored Bidding format data 20025, so that the bidder computer can verify that bids submitted by the bidder satisfy the bidding format. In FIG. 24, an operating system 20022 and a Bidder client program 20021 are fully or partly uploaded in the memory 20020. Thus, the CPU 20030 of the bidder computer 20000, as exemplified in FIG. 23, is ready to run a bidder client (process). As shown in FIG. 16, the bidder client program 70001 can also be stored on a non-transitory, machine readable medium 70000. The machine readable medium could be removable and may correspond to the Removable machine readable medium 20040 in FIG. 23.

With a computer we mean any general purpose device that can be instructed (programmed) to carry out a set of arithmetic or logical operations automatically. It could for example be a personal computer (portable or stationary), a work station, a desktop, a laptop, a mainframe computer, a supercomputer, a smart phone, a tablet, a terminal, a parallel computer, a quantum computer, a computerized wristwatch or other wearable computers. A computer could be embedded in a machine and it may not have a user interface. With terminal we mean an electronic or electromechanical hardware device that is used for entering data into, and outputting data from, a computing system. FIG. 7 is an example that schematically illustrates the possible architecture of a computer.

We use the term processor unit to denote any hardware that can perform arithmetic and logic operations. Often computers have a control unit that, by providing control signals, directs the operation of the memory, processor unit and any input and output devices how to respond to programmed instructions. Similar to practice, we use the term Central Processing Unit (CPU) to denote the combination of a processor unit and control unit. The more general term Processor system has at least one processor unit and at least one control unit. Thus, one CPU or a group of CPU:s would constitute a Processor system. In the future, a quantum processor could be part of a Processor system. A Processor system could, for example, include an integrated circuit (IC), an application-specific integrated circuit (ASIC) or a field-programmable gate array (FPGA). A Processor system could also include neural processors that can learn on their own once they are programmed.

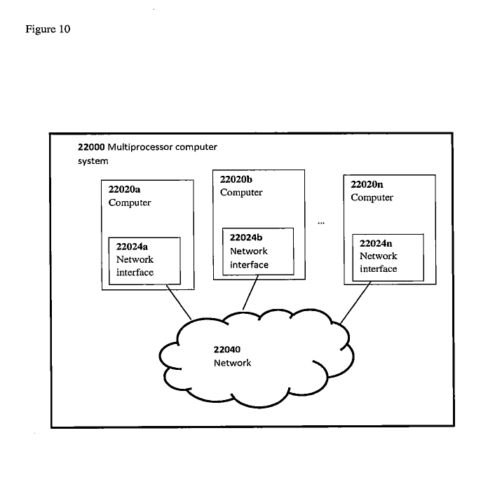

We use the term multiprocessor system to denote a Processor system with more than one processor unit. In practice a multiprocessor system would often have several CPU:s, as illustrated by FIG. 9. But according to our definition of a multiprocessor system, the number of processor units and control units could be different. For example, a multiprocessor system could have just one control unit. Control units and/or CPU:s in a multiprocessor system can for example interact by sharing resources—such as memory, I/O devices, information and time—and/or by sending messages. Dual-core, multi-core, multi-CPU are all examples of Processor systems that also are multiprocessor systems. We use the term multiprocessor computer system to denote a computer system that includes a multiprocessor system.

Tightly coupled multiprocessor systems normally contain multiple processor units that are connected at the bus level. These processor units may have access to a central shared memory, or may participate in a memory hierarchy with both local and shared memory. Processor units in tightly coupled multiprocessor systems often exchange information through a shared memory space.

Loosely coupled multiprocessor systems (clusters) are normally based on multiple standalone computers that are interconnected via a high speed communication system. In this case, the processor units normally communicate with each other via message passing or interconnection switching.

We use the term bus generally: it denotes the communication system that transfers data between components inside a computer. Thus, in our specification the term bus would include alternative topologies of the network that connects components inside a computer, such as a mesh network, a ring network, a bus network, a tree network, a hypercube network, and a butterfly network. The interconnection could be hard-wired (static), or it could be dynamic. In the latter case, switches can be used to change connections between components inside a computer. Examples of dynamic interconnections are crossbar networks, omega networks, multi-stage interconnection networks and single-stage interconnection networks.

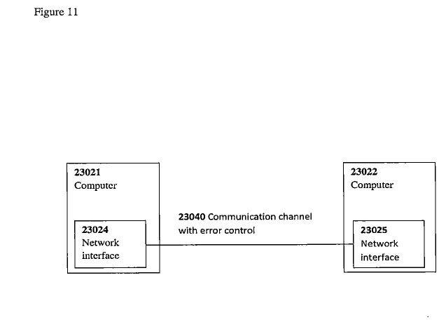

The computer in FIG. 9 has a plurality (two or more) of CPU:s and memories that are connected by a bus. The bus can for example have any of the properties discussed in the previous paragraph. Memories might be shared by the CPU:s. The multiprocessor system could for example use uniform memory access (UMA). The multiprocessor system could also have non-uniform access (NUMA). In the latter case, each CPU could have a local memory, which might be a cache memory. The input/output system in FIG. 9 could represent one or more user-interfaces and/or one or more network interfaces. FIG. 9 would normally represent a single computer with a tightly coupled multiprocessor system. FIG. 10 illustrates a computer system with a plurality of (two or more) computers that are connected by a network. This is also a multiprocessor computer system. We refer to it as a distributed multiprocessor computer system.

One advantage with a multiprocessor computer system is that programs can be executed in parallel, synchronously or asynchronously, on two or more processor units. This property can for example be used to speed up the operation of an auction for steps that can be executed in parallel. Independence transformations and other aspects of our invention can be used to facilitate that steps of the auction process can be executed in parallel. Thus in an exemplary embodiment, parts of the auction process would be executed by a multiprocessor computer system.

Computers often have several types of memories. With memory we mean any non-transitory, physical device used to store programs (sequences of instructions) or data (e.g. program state information) on a temporary or permanent basis that can interact with a computer, and any combination of such non-transitory, physical devices. The memory could be volatile, i.e. require battery or some other energy source to maintain the stored information, or be non-volatile. Examples of volatile memories that can be used in computers are Static RAM (SRAM), dynamic RAM (DRAM), Z_RAM, TTRAM, A-RAM and ETA RAM. Examples of non-volatile memories include read-only memory (ROM), PROM, EPROM, EEPROM, flash memory, magnetic storage devices (e.g. hard disks, floppy discs and magnetic tape), optical discs, paper tape and punched cards, FeRAM, CBRAM, PRAM, SONOS, RRAM, Racetrack memory, NRAM and Millipede. It is not necessary for our invention, but computers often use a relatively small fast and expensive memory close to the CPU, such as a cache memory, and a slower but larger and cheaper storage farther away from the CPU. The data storage device in FIG. 7 could, for example, represent the latter type of memory. It could for example be a tape, magnetic disks, flash memory and optical discs (CD-ROM and DVD-ROM). With a non-transitory machine-readable medium we mean any non-transitory memory, including non-transitory data storage devices, and any combination of such memories.

With user interface we broadly speaking mean a system of hardware and/or software that the computer uses to present information (such as graphic, text and sound) to a human operator and to register control sequences (such as keystrokes with the computer keyboard, movements of the computer mouse or other cursor controls, selections with a touchscreen, voice commands, eye movements, gestures) that the user employs to control the program. However, bidders will not necessarily input bids through a user interface. In some cases, bidders may let a computer prepare and submit their bids automatically, perhaps with some human oversight. In an exemplary embodiment of the invention, the auctioneer has access to the server when the auction is running, but one can think of embodiments where this would not be necessary for the normal operation of the auction.

The (computer) network is a communications system that allows computers to exchange data. The connections (network links) between nodes in the network are normally established using either cable media (such as electrical cables or optical fibers), wireless media (such as terrestrial microwaves, communication satellites, cellular systems, radio and spread spectrum technologies, infrared communication) or combinations of such technologies. There are many different communication protocols that can be used in a network. Examples are: Ethernet, token-ring, Internet Protocol Suite, Virtual Private Network (VPN), Digital Subscriber Line (DSL), Plain Old Telephone Service (POTS), Integrated Services Digital Network (ISDN), Synchronous optical networking (SONET), Synchronous Digital Hierarchy (SDH), Asynchronous Transfer Mode (ATM), cellular data communication protocols, electronic mail or a facsimile system. The same network can use different protocols in parallel or in different parts of the network. The network can be classified as a local area network or wide area network, or different parts of the network can be local areas or wide areas. Ideally the communication between a bidder and the auction server would be secure, and the communication could be partly encrypted.

Computers in an auction computer system are physically connected through the hardware of the network. In order to communicate, computers also need software that provides a logical connection with communication protocols etc. We use the term communication channel to describe the physical and logical connection of two computers in the computer system.

Communication through a network is often subject to noise. To avoid misunderstandings, it is often desirable that communication between computers in an auction computer system has some type of error control. Error detection techniques usually add a tag to the message, such that the tag depends on the message. When receiving the message, the receiver can then check that the tag matches the message. A mismatch indicates that the message has been distorted, and that it should be corrected. With forward error correction (FEC), the receiver uses information in the tag to correct the message. A slower, but often more secure process, is to let the sender send the message again until the receiver can verify that it is correct. Automatic Repeat reQuest (ARQ) is one version of the latter. ARQ and FEC may be combined, such that minor errors are corrected without resending the message, and major errors are corrected via a request for retransmission: this is called hybrid automatic repeat-request (HARQ). Applications that require extremely low error rates (such as digital money transfers) often use ARQ.

An exemplary embodiment of an auction computer system would use error control, such as ARQ, to make sure that bids and other information is not distorted when sent between the auction computer and bidder computers.

With a network interface we mean the system of software and/or hardware that is used to connect a computer to a computer network. A computer sometimes has multiple ways of connecting to the network, such as one type of interface to cable media and one or more types of interfaces to wireless media. In our specification we let the network interface of a computer be an aggregated interface that represents all the ways the computer can be connected to the network.

### Definitions and Conventions

We use the definitions and conventions below when claiming aspects of our invention.

We say that an auction is well-regulated if trading is regulated by all of the following rules: bidding format, allocation rule and pricing rule.

With a three-non-zero-digit number we mean a number, such as an integer, a decimal number or a fraction that has been converted to a corresponding decimal number, with at least three non-zero digits. Examples of three-non-zero-digit numbers are 7071, 1.0042, 6665, 1.33333 and 7.77.

1. A method for enabling a bidder to participate in an auction that trades a plurality of different item types, said method implemented in a multiprocessor computer system comprising:
i) an auction computer;
ii) a bidder computer;
iii) a computer network connecting said auction computer and bidder computer;
said method comprising
a) storing a definition of a plurality of package types at said bidder computer, such that
i) said plurality of package types are different from each other;
ii) said plurality of package types are partly linearly independent;
iii) each of said plurality of different item types is contained in at least one of said plurality of package types;
iv) at least one of said plurality of different item types is contained in at least two of said plurality of package types;
v) each of said plurality of package types contains at least one of said plurality of different item types, and no other item type;
vi) there is at least one out of said plurality of package types that contains at least two of said plurality of different item types;
b) receiving bids at said bidder computer, such that it is possible for said bidder to enter at least one bid for at least one of said plurality of package types in one or more bidding rounds;
c) verifying that said at least one bid satisfies a bidding format;
d) providing possibility to communicate said at least one bid for at least one of said plurality of package types to said auction computer via said computer network, wherein error control is applied in said providing possibility to communicate said at least one bid;
e) providing possibility to communicate said definition of a plurality of package types between said auction computer and said bidder computer;
f) clearing said auction at said auction computer to determine the allocation for at least some of said plurality of different item types.

2. A method as recited in claim 1, wherein said plurality of package types are linearly independent.

3. A method as recited in claim 1, wherein at least one of said plurality of package types contains a quantity of at least one of said plurality of different item types, wherein the quantity is a three-non-zero-digit number.

4. A method as recited in claim 3, wherein at least one of said plurality of package types is defined to have a positive quantity of at least one of said plurality of different item types and a negative quantity of at least one of said plurality of different item types.

5. A method as recited in claim 4, wherein a number of said plurality of package types is at least as large as a number of said plurality of different item types.

6. A method as recited in claim 5, wherein said one or more bidding rounds is one bidding round.

7. A method as recited in claim 1, wherein said step of clearing said auction further comprises determining marginal prices for at least two of said plurality of package types, such that said at least two of said plurality of package types are approximately independent for said bidder at said marginal prices.

8. A method as recited in claim 1, further comprising up-dating said definition of the plurality of package types automatically.

9. A method as recited in claim 8, wherein said up-dating makes use of a technique that approximately jointly diagonalizes a plurality of matrices.

10. A method for enabling a bidder to participate in an auction that trades a plurality of different item types, said method implemented in a multiprocessor computer system comprising:
i) an auction computer;
ii) a bidder computer;
iii) a computer network connecting said auction computer and bidder computer;
said method comprising
a) Storing a definition of a plurality of package types at said bidder computer, such that:
i) said plurality of package types are different from each other;
ii) each of said plurality of different item types is contained in at least one of said plurality of package types;
iii) each of said plurality of package types contains at least one of said plurality of different item types, and no other item type;
b) Storing definition of another plurality of package types at said auction computer, such that:
iv) said another plurality of package types are different from each other;
v) each of said plurality of different item types is contained in at least one of said another plurality of package types;
vi) each of said another plurality of package types contains at least one of said plurality of different item types, and no other item type;
vii) at least one of said another plurality of package types is different from all of said plurality of package types;
c) receiving bids at said bidder computer, such that it is possible for said bidder to enter at least one bid for at least one of said plurality of package types in one or more bidding rounds;
d) verifying that said at least one bid satisfies a bidding format;
e) providing possibility to communicate said at least one bid for each of said plurality of package types to said auction computer via said computer network, wherein error control is applied in said providing possibility to communicate said at least one bid;
f) providing possibility to communicate package definitions between said auction computer and said bidder computer, where said package definitions include at least one of the following:
i) said definition of a plurality of package types;
ii) said definition of another plurality of package types;
g) clearing said auction to determine the allocation for at least some of said plurality of different item types.
h) performing a price-quantity data transformation, wherein said price-quantity data transformation is locally approximately invariant with respect to transaction costs and where said price-quantity data transformation has at least one of the following directions:
i) from said plurality of package types to said another plurality of package types;
ii) from said another plurality of package types to said plurality of package types;

11. A method as recited in claim 10, wherein said definition of said plurality of package types has been chosen by said bidder.

12. A method as recited in claim 10, wherein at least one of the following is valid:
i) at least one out of said plurality of package types contains at least two of said plurality of different item types;
ii) at least one out of said another plurality of package types contains at least two of said plurality of different item types.

13. A method as recited in claim 10, wherein both of the following are valid:
i) at least one out of said plurality of package types contains at least two of said plurality of different item types;
ii) at least one out of said another plurality of package types contains at least two of said plurality of different item types.

14. A method as recited in claim 13, further including performing another price-quantity data transformation, such that the auction process comprises price-quantity data transformations in both directions:
i) from said plurality of package types to said another plurality of package types,
ii) from said another plurality of package types to said plurality of package types.

15. A method as recited in claim 14, wherein said one or more bidding rounds is one bidding round.

16. A method as recited in claim 15, wherein said receiving bids at said bidder computer, such that it is possible for said bidder to enter at least one bid for at least one of said plurality of different packages, such that said bidder has the possibility to choose one or more bid prices implicitly.

17. A machine that is a useful component when running an auction that trades a plurality of different item types, comprising:
i) a network interface that receives bid data;
ii) a non-transitory machine-readable medium storing
a) a package definition comprising package type A and package type B, such that
i) package type A and package type B are different;
ii) package type A contains at least one of said plurality of different item types;
iii) package type B contains at least two of said plurality of different item types;
iv) package type B contains a quantity that is a three-non-zero-digit number of at least one of said plurality of different item types.
b) said bid data, wherein parts of said bid data are associated with package type A and parts of said bid data are associated with package type B;
c) a sequence of instructions A, where the sequence of instructions A is relevant for package type A and said parts of said bid data are associated with package type A, wherein the sequence of instructions A do not have any reference to package type B and wherein the sequence of instructions A do not have any reference to said parts of said bid data are associated with package type B;
d) a sequence of instructions B, where the sequence of instructions B is relevant for package type B and said parts of said bid data are associated with package type B and where the sequence of instructions B do not have any reference to package type A and wherein the sequence of instructions B do not have any reference to said parts of said bid data are associated with package type A;
iii) a multiprocessor system comprising two processor units, such that:
a) one of said two processor units can execute the sequence of instructions A while the other of said two processor units simultaneously execute the sequence of instructions B;
iv) a bus to transfer information between said network interface, said non-transitory machine-readable medium and said multiprocessor system;

18. A machine as recited in claim 17, wherein package B is defined to have a positive quantity of at least one of said plurality of different item types and a negative quantity of another of said plurality of different item types.

19. A machine as recited in claim 17, wherein packages in said package definition comprising package type A and package type B are partly linearly independent.

20. A machine as recited in claim 17, wherein said package definition comprising package type A and package type B is up-dated automatically.
